(19) United States
(12) Patent Application Publication
(10) Pub. No.: US 2026/0257696 A1
(43) Pub. Date: Sep. 3, 2026

(54) ELECTRONIC DEVICE AND METHOD FOR DETERMINING DRIVING PATH USING CAMERA

(71) Applicant: THINKWARE CORPORATION, Seongnam-si (KR)

(72) Inventors: Sukpil KO, Seongnam-si (KR); Yechan CHOI, Seongnam-si (KR); Taekyu HAN, Seongnam-si (KR)

(21) Appl. No.: 19/553,287

(22) Filed: Feb. 28, 2026

(30) Foreign Application Priority Data
Feb. 28, 2025 (KR) 10-2025-0026725
Feb. 27, 2026 (KR) 10-2026-0036836

(51) Int. Cl. B60W 60/00; B60W 30/14; G06T 7/50; G06V 10/20; G06V 10/764; G06V 10/82; G06V 20/56; G06V 20/58

(52) U.S. Cl. CPC B60W 60/0011; B60W 30/143; G06T 7/50; G06V 10/255; G06V 10/764; G06V 20/58; G06V 20/588; B60W 2420/403; B60W 2530/10; B60W 2552/15; G06T 2207/20081; G06T 2207/20084; G06T 2207/30252; G06V 10/82

(57) ABSTRACT

An electronic device for controlling a vehicle includes a camera, at least one processor. The at least one processor is configured to obtain an image via the camera, and obtain a depth map corresponding to the image by inputting the image to a trained model. The at least one processor is configured to determine a driving path of the vehicle by using the depth map for autonomous driving of the vehicle positioned off a paved road. The at least one processor is configured to generate a control signal for controlling the vehicle in accordance with the determined driving path.

### TECHNICAL FIELD

The present disclosure relates to an electronic device and a method for determining a driving path using a camera.

### BACKGROUND

An electronic device may be mounted on a vehicle. The electronic device may obtain an image through a camera. The electronic device may identify an object in the obtained image. The electronic device may use the obtained image for autonomous driving of the vehicle.

The above-described information may be provided as a related art for the purpose of helping understanding of the present disclosure. No argument or decision is made as to whether any of the above description may be applied as a prior art related to the present disclosure.

### SUMMARY

According to an embodiment, an electronic device for controlling a vehicle is disclosed. The electronic device may comprise a camera. The electronic device may comprise at least one processor. The at least one processor may be configured to obtain an image via the camera. The at least one processor may be configured to obtain a depth map corresponding to the image by inputting the image to a trained model. The at least one processor may be configured to determine a driving path of the vehicle by using the depth map for autonomous driving of the vehicle positioned off a paved road. The at least one processor may be configured to generate a control signal for controlling the vehicle in accordance with the determined driving path.

According to an embodiment, an electronic device for controlling a vehicle is disclosed. The electronic device may comprise a camera. The electronic device may comprise at least one processor. The at least one processor may be configured to obtain an image via the camera. The at least one processor may be configured to, when the vehicle is positioned on a paved road, determine a first driving path of the vehicle based on a shape of the paved road identified by using the image. The at least one processor may be configured to, when the vehicle is positioned on a paved road, generate a first control signal for controlling the vehicle according to the first driving path. The at least one processor may be configured to, when the vehicle is positioned off the paved road, obtain a depth map corresponding to the image by inputting the image to a trained model. The at least one processor may be configured to, when the vehicle is positioned off the paved road, determine a second driving path of the vehicle by using the depth map. The at least one processor may be configured to, when the vehicle is positioned off the paved road, generate a second control signal for controlling the vehicle according to the second driving path.

A method executed by an electronic device for controlling a vehicle including a camera and at least one processor is provided. The method may comprise obtaining an image via the camera. The method may comprise obtaining a depth map corresponding to the image by inputting the image to a trained model. The method may comprise determining a driving path of the vehicle by using the depth map for autonomous driving of the vehicle positioned off a paved road. The method may comprise generating a control signal for controlling the vehicle in accordance with the determined driving path.

### BRIEF DESCRIPTION OF DRAWINGS

FIG. 1 is a schematic view of an electronic device according to an embodiment.

FIG. 2 illustrates a vehicle positioned off a paved road.

FIG. 3 is a flowchart representing an operation of an electronic device for determining a driving path of a vehicle.

FIG. 4 illustrates an image obtained by a camera of an electronic device.

FIG. 5 illustrates a depth map corresponding to an image obtained via a camera.

FIG. 6 is a flowchart representing an operation of an electronic device for determining a driving speed of a vehicle.

FIG. 7 is a flowchart representing an operation of an electronic device for determining a driving path of a vehicle according to an embodiment.

FIG. 8 illustrates an image including a road obtained by a camera according to an embodiment.

FIG. 9 illustrates an image including a classified object according to an embodiment.

FIG. 10 illustrates an example of a block diagram illustrating an autonomous driving system of a vehicle according to an embodiment.

FIG. 11 and FIG. 12 illustrate an example of a block diagram representing an autonomous driving mobile body according to an embodiment.

FIG. 13 illustrates an example of a gateway associated with a user device according to various embodiments.

FIG. 14 is a diagram for describing an operation of an electronic device training a neural network based on a set of training data according to an embodiment.

FIG. 15 is a block diagram of an electronic device according to an embodiment.

FIG. 16 is a functional block diagram of an autonomous driving system planning a driving path by using an object recognition result according to another embodiment of the present invention.

FIG. 17 is a conceptual diagram illustrating a process in which different optimal paths are generated according to a mission purpose even when having the same start point and goal point on the same drivability map, according to an embodiment of the present invention.

FIG. 18 is a conceptual diagram for describing an operation of a mission planner and a path planner illustrated in FIG. 16 in more detail.

FIG. 19 is a flowchart illustrating a flow of an optimal path generation algorithm according to an embodiment of the present invention.

FIG. 20 is a conceptual diagram comprehensively illustrating a process in which different optimal paths are generated by applying a dynamic cost function according to a mission purpose even when the same terrain environment is input, according to an embodiment of the present invention.

FIG. 21 is a flowchart illustrating a flow of an unpaved road autonomous driving path planning method according to an embodiment of the present invention.

### DETAILED DESCRIPTION

Specific structural or functional descriptions of embodiments according to a concept of the present invention disclosed in the present specification are exemplified only for a purpose for describing embodiments according to the concept of the present invention, and embodiments according to the concept of the present invention may be implemented in various forms and are not limited to embodiments described in the present specification.

Since embodiments according to the concept of the present invention may apply various changes and have various forms, embodiments will be exemplified in the drawings and described in detail in the present specification. However, this is not intended to limit embodiments according to the concept of the present invention to specific disclosure forms, and includes a modification, an equivalent, or a substitute included in a spirit and technical scope of the present invention.

Although terms such as first or second may be used to describe various components, the components should not be limited by the terms. The terms are used for a purpose of distinguishing one component from another component, and for example, without departing from a scope of rights according to the concept of the present invention, a first component may be referred to as a second component and similarly the second component may also be referred to as the first component.

When a component is mentioned to be “connected” or “accessed” to another component, it should be understood that it may be directly connected or accessed to the another component, but another component may exist in a middle. On the other hand, when a component is mentioned to be “directly connected” or “directly connected” to another component, it should be understood that no other component exists in the middle. Expressions that describe a relationship between components, such as “between” and “directly between” or “directly adjacent to”, and the like, should be interpreted in the same manner.

A term used in the present specification is used only to describe specific embodiments and is not intended to limit the present invention. A singular expression includes a plural expression unless context clearly indicates otherwise. In the present specification, a term such as “include” or “have”, and the like are intended to be designated as existence of a described feature, number, step, operation, component, part, or combination thereof and should be understood not to pre-exclude a possibility of the existence or addition of one or more other features, number, step, operation, component, part, or combination thereof.

Unless otherwise defined, all terms used herein, including technical or scientific terms, have the same meaning as commonly understood by a person of ordinary skill in the art to which the present invention belongs. Terms defined in commonly used dictionaries should be interpreted as having a meaning consistent with the meaning of context of relevant technology, and are not interpreted in an ideal or overly formal sense unless explicitly defined in the present specification.

Hereinafter, embodiments will be described in detail with reference to the accompanying drawings. However, a scope of a patent application is not limited or restricted by these embodiments. The same reference numerals presented in each drawing may indicate the same configuration, and overlapping descriptions thereof may be omitted.

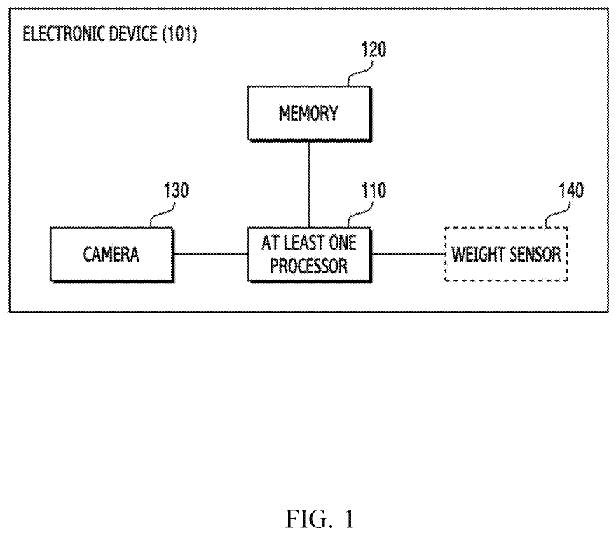

FIG. 1 is a schematic view of an electronic device according to an embodiment.

An electronic device 101 (or an external electronic device) according to various embodiments disclosed in the present document may be a device of various forms. For example, the electronic device 101 may include a computer device, a portable multimedia device, a camera (e.g., a dash cam), a wearable device, a server, or a home appliance. The electronic device 101 (or the external electronic device) according to embodiments of the present document is not limited to the above-described devices.

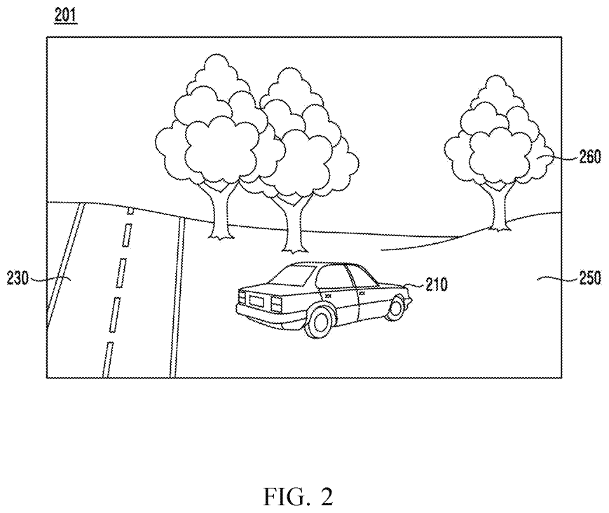

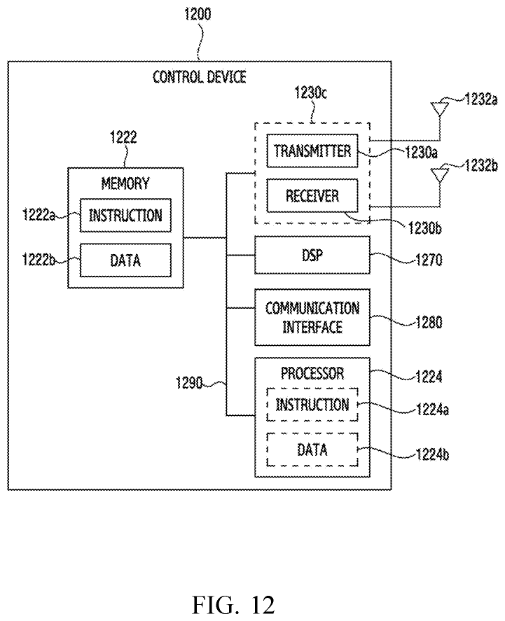

Referring to FIG. 1, the electronic device 101 may include an electronic device 101 included in a vehicle (e.g., a vehicle 210 of FIG. 2). For example, the electronic device 101 may be mounted on the vehicle 210. For example, the electronic device 101 may correspond to a device (e.g., a dash cam) attached to the vehicle 210, or may be included in the device. However, the present disclosure is not limited thereto. For example, the electronic device 101 may be built-in to the vehicle 210. For example, the electronic device 101 may correspond to an electronic control unit (ECU) in the vehicle 210, or may be included in the ECU. The ECU may be referred to as an electronic control module (ECM). The electronic device 101 of FIG. 1 may include at least a portion of a control device 1200 of FIG. 12 or may correspond to at least a portion of the control device 1200 of FIG. 12.

The electronic device 101 may include at least one processor 110, memory 120, and a camera 130. For example, the electronic device 101 may further include a weight sensor 140. A portion of hardware of FIG. 1 may be implemented as a single integrated circuit, such as a system on a chip (SoC). A type and/or the number of hardware included in the electronic device 101 are not limited to those illustrated in FIG. 1. For example, the electronic device 101 may include only some of the hardware illustrated in FIG. 1.

The at least one processor 110 may include at least a portion of a processor 1224 of FIG. 12 or may correspond to at least a portion of the processor 1224 of FIG. 12. The at least one processor 110 may include a central processing unit (CPU) (e.g., including processing circuitry) and a display processing unit (DPU) (e.g., including processing circuitry). As a non-limiting example, the at least one processor 110 may further include a graphics processing unit (GPU) (e.g., including processing circuitry). The at least one processor 110 may be configured to execute instructions stored in the memory 120. As a non-limiting example, the at least one processor 110 may perform at least some of operations described in the present disclosure by using an artificial intelligence model (e.g., a generative artificial intelligence (AI) model).

The memory 120 may include one or more storage media (or storage mediums). For example, the one or more storage media may include a hard drive, flash memory, a permanent memory such as read-only memory (ROM), a semi-permanent memory such as random access memory (RAM), any other suitable type of storage assembly, or any combination thereof. The memory 120 may include a cache memory (e.g., which may be included in the at least one processor 110), which is one or more different types of memory used to temporarily store data for a function (or a feature) of an electronic device 101. The memory 120 may be fixedly embedded in the electronic device 101 or may be incorporated into one or more suitable types of components (e.g., a subscriber identity module (SIM) card and/or a secure digital (SD) memory card), which may be repeatedly inserted into the electronic device 101 and removed from the electronic device 101. For example, the memory 120 may include at least a portion of memory 1222 of FIG. 12 or may correspond to at least a portion of the memory 1222 of FIG. 12.

The camera 130 of the electronic device 101 may include one or more lenses and an image sensor. For example, the one or more lenses may be implemented as a lens assembly. The lens assembly may include a wide-angle lens or a telephoto lens. The one or more lenses may collect light around the camera 130 (or around the electronic device 101) to obtain an image.

For example, the image sensor in the camera 130 may convert light collected by using the one or more lenses into an electrical signal to obtain an image. The image sensor may include, for example, one image sensor selected from among image sensors having different properties, such as a red, green, blue (RGB) sensor, a black and white (BW) sensor, an infrared (IR) sensor, or a ultra violet (UV) sensor, a plurality of image sensors having the same property, or a plurality of image sensors having different properties. Each image sensor included in the image sensor may be implemented by using, for example, a charged coupled device (CCD) sensor or a complementary metal oxide semiconductor (CMOS) sensor.

The electronic device 101 may include the weight sensor 140. For example, the electronic device 101 may include the weight sensor 140 for sensing a weight of the vehicle 210 varying according to a load (e.g., cargo and/or a passenger) of the vehicle 210. For example, the weight sensor 140 may include a load cell, a strain gauge, a pressure sensor, and/or a capacitance sensor, but is not limited thereto. Data on the weight of the vehicle 210 obtained by the weight sensor 140 may be transmitted to the at least one processor 110 of the electronic device 101. The weight sensor 140 may not be an essential component of the electronic device 101. For example, the weight sensor 140 may be an optional component of the electronic device 101. For example, the electronic device 101 may receive the data on the weight of the vehicle 210 from the vehicle 210 via a communication interface (e.g., the communication interface 1280 of FIG. 12).

FIG. 2 illustrates a vehicle positioned off a paved road.

Referring to FIG. 2, an environment 201 may include a vehicle 210, an obstacle 260, a paved road 230, and an area 250 outside the paved road 230.

The paved road 230 may mean a driving environment artificially constructed to support driving of the vehicle 210. For example, the paved road 230 may include a road surface designed such that the vehicle 210 may stably drive. For example, the paved road 230 may be described as a road paved with a paving material (e.g., asphalt and/or concrete). For example, the paved road 230 may include a visual boundary (e.g., a lane, a median strip, a guide rail, and/or a curb) guiding driving.

The area 250 outside the paved road 230 may mean an environment that is not designed for a purpose of driving of the vehicle 210. For example, the area 250 outside the paved road 230 may be described as an unpaved road, an off-road environment, and/or an unstructured environment. For example, the area 250 outside the paved road 230 may include unpaved ground (e.g., a lawn, a rice paddy path, a dirt road, a gravel field, and/or a sandy beach).

The obstacle 260 may mean a physical object interfering with driving of the vehicle 210. For example, the obstacle 260 may be described as an object through which the vehicle 210 may not physically pass, or that has a risk of vehicle body damage or rollover when passing. For example, the obstacle 260 may include an object (e.g., a tree, a rock, and/or a stump) protruding from the ground. For example, the obstacle 260 may include an object (e.g., a pit, a puddle, and/or a drainage ditch) recessed from the ground.

The vehicle 210 may include a mobile body configured to move on the ground. For example, the vehicle 210 may include an autonomous driving mobile body driving according to a control signal received from an electronic device 101 without manipulation of a driver. For example, the vehicle 210 may include a vehicle (e.g., a passenger car and/or a bus) driving on the paved road 230. For example, the vehicle 210 may include a special-purpose cart (e.g., a golf cart, an article transport cart, and/or a mobile means for low-speed driving). For example, the vehicle 210 may include an agricultural machine (e.g., a tractor and/or a combine). For example, the vehicle 210 may include a construction machine.

Autonomous driving technology of a vehicle may be designed on a premise of a vehicle driving on the paved road 230. For example, an artificial intelligence model for autonomous driving may be trained based on road data including a lane, a road boundary, and a sign. For example, the artificial intelligence model for autonomous driving of a vehicle may be trained to identify the paved road 230 and perform autonomous driving based on the identified paved road 230. When the vehicle 210 is positioned off the paved road 230, the autonomous driving technology designed on the premise of the vehicle driving on the paved road 230 may not be used.

In order to guide a driving path of the vehicle 210 positioned off the paved road 230, a guide wire buried in the ground may be used. However, when the guide wire is used, a high initial installation cost for infrastructure construction and a continuous maintenance cost may be consumed. A guide wire method following a predefined driving path may not be able to respond in real time to the obstacle 260 generated on the ground.

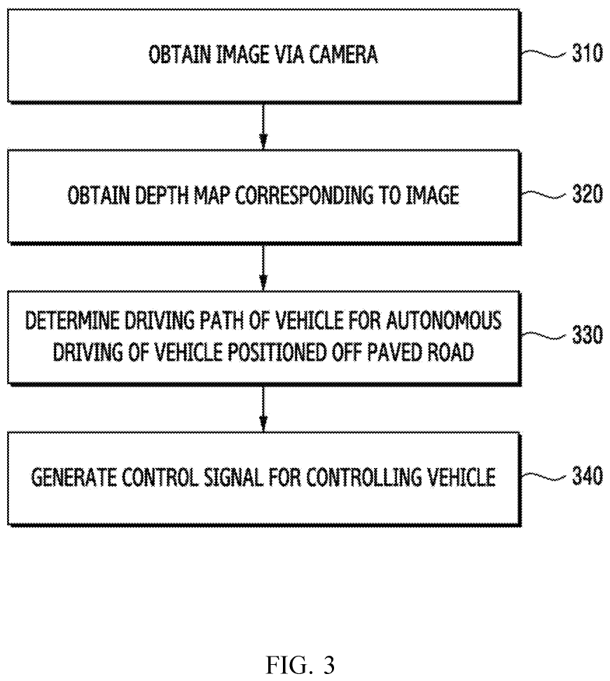

The electronic device 101 may be required an operation for autonomous driving technology, which is performed in the area 250 outside the paved road 230 and consumes a relatively low cost. An operation of the electronic device 101 for autonomous driving of the vehicle 210 in an area outside the paved road 230 will described below through FIGS. 3 to 5.

FIG. 3 is a flowchart representing an operation of an electronic device for determining a driving path of a vehicle.

Operations of FIG. 3 may be performed by the electronic device 101 and/or the at least one processor 110 of FIG. 1. The operations of FIG. 3 may be sequentially performed, but are not necessarily performed sequentially. For example, an order of the operations of FIG. 3 may be changed, and at least two operations among the operations of FIG. 3 may be performed in parallel.

Referring to FIG. 3, in operation 310, the electronic device 101 may obtain an image via a camera 130. The camera 130 may be positioned to face a front of a vehicle (e.g., the vehicle 210 of FIG. 2). For example, the electronic device 101 may obtain the image via the camera 130 capturing the front of the vehicle 210. For example, the electronic device 101 may obtain, in real time, the image capturing the front of the vehicle 210 via the camera 130 while the vehicle 210 is driving. The image may include a frame image included in a video obtained by the camera 130. However, the present disclosure is not limited thereto. For example, the electronic device 101 may receive, via a communication interface (e.g., a communication interface 1280 of FIG. 12), an image obtained by a camera (not illustrated) included in the vehicle 210.

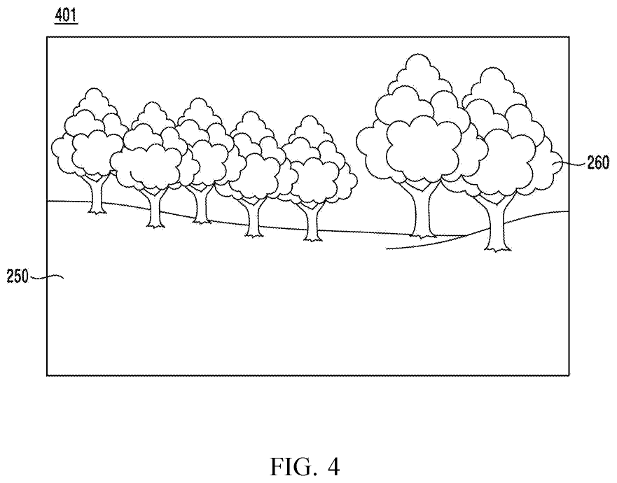

FIG. 4 illustrates an image obtained by a camera of an electronic device.

Referring to FIG. 4, an image 401 may be described as an image obtained by a camera 130 of an electronic device 101. According to an embodiment, the image 401 may be described as an image capturing a front of a vehicle 210 positioned off a paved road 230. As a non-limiting example, the image 401 may include an area 250 outside the paved road 230 and an obstacle 260. For example, the paved road 230 may not be included in the image 401.

According to an embodiment, the image 401 may include an image 401 obtained by a single camera. However, the present disclosure is not limited thereto. The image 401 may include a composite image of images obtained by a plurality of cameras.

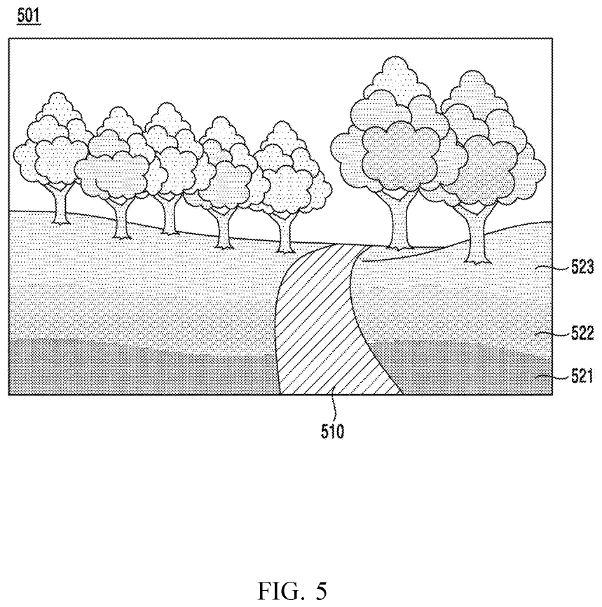

Referring again to FIG. 3, in operation 320, the electronic device 101 may obtain (or generate) a depth map (e.g., a depth map 501 of FIG. 5) by using the image 401. For example, the electronic device 101 may obtain the depth map 501 corresponding to the image 401 by inputting the image 401 to a trained model. For example, the electronic device 101 may obtain the depth map 501 by providing the image 401 obtained via the single camera to the trained model. The trained model may include a depth estimation model (e.g., stable diffusion and/or depth anything).

According to an embodiment, the electronic device 101 may obtain depth information of external objects included in the image 401 by using the trained model. The depth information may indicate depth values of each of pixels of the image 401. For example, the depth value may indicate a distance from the camera 130 to an external object in the image 401. For example, the electronic device 101 may obtain the depth map 501 for configuring the external objects in a three-dimensional space by using depth information of the pixels of the image 401.

FIG. 5 illustrates a depth map corresponding to an image obtained via a camera.

Referring to FIG. 5, a depth map 501 corresponding to an image 401 is illustrated. For example, an electronic device 101 may obtain the depth map 501 configured in three dimensions by using coordinate values and depth information of external objects in the image 401.

According to an embodiment, the depth map 501 may visualize and represent distance information corresponding to each of pixels in the image 401. For example, a color may be differently determined according to the distance information of the pixels. For example, in a ground area, a first area 521 having a relatively short distance may be represented in a dark color, and a third area 523 having a relatively long distance may be represented in a bright color. A second area 522 between the first area 521 and the third area 523 may be represented in an intermediate color.

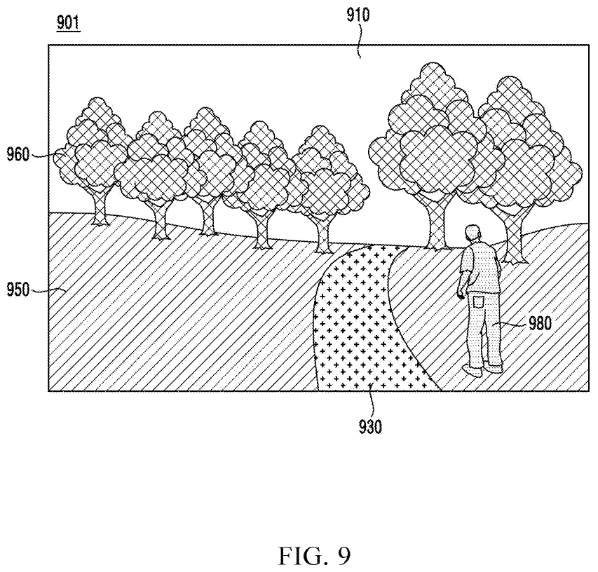

According to an embodiment, the electronic device 101 may identify distance information of objects included in the image 401 by using the depth map 501. For example, the electronic device 101 may identify distance information of objects classified using an image segmentation technique, by using the depth map 501. For example, the electronic device 101 may identify the distance information of the objects via the depth map 501 having the same size as a segmentation map (e.g., an image 901 of FIG. 9) including the objects classified via the image segmentation technique. For example, the electronic device 101 may identify distance information of the ground area via the depth map 501.

Referring again to FIG. 3, in operation 330, the electronic device 101 may determine a driving path (e.g., a driving path 510 of FIG. 5) of the vehicle for autonomous driving of the vehicle 210 positioned off a paved road 230. For example, the electronic device 101 may determine the driving path 510 using the depth map 501 for autonomous driving of the vehicle 210 positioned in an area 250 outside the paved road 230.

According to an embodiment, the electronic device 101 may identify a drivable area of the vehicle 210 by using the depth map 501. For example, the electronic device 101 may identify the drivable area of the vehicle 210 by inputting the depth map 501 to a trained model. The electronic device 101 may determine the driving path 510 according to destination information and the drivable area of the vehicle 210. As a non-limiting example, the electronic device 101 may determine the driving path 510 in which a plurality of drivable areas are connected such that a time required to a destination is minimized.

According to an embodiment, the electronic device 101 may determine (or set) the driving path 510 based on specification information of the vehicle 210. As a non-limiting example, the specification information of the vehicle 210 may include a vehicle width of the vehicle 210, a height of the vehicle 210, a minimum turning radius of the vehicle 210, and/or a distance between a front-wheel axle of the vehicle 210 and the camera 130.

For example, the electronic device 101 may determine the driving path 510 in consideration of the width of the vehicle 210. In an embodiment, when a distance between obstacles 260 is narrower than the width of the vehicle 210, the electronic device 101 may determine the driving path 510 such that the vehicle 210 does not pass between the obstacles 260.

According to an embodiment, the electronic device 101 may determine the driving path 510 based on a slope (or a gradient or an inclination) of a ground area included in the image 401. For example, the electronic device 101 may identify the slope of the ground area included in the image 401 by using the depth map 501. For example, the electronic device 101 may identify the slope of the ground area via depth information of pixels corresponding to the ground area. For example, the electronic device 101 may determine the driving path 510 of the vehicle 210 to avoid the ground area, based on the slope of the ground area identified as above a threshold slope.

The threshold slope may be described as a slope of a ground area where the vehicle 210 may not drive. The threshold slope may be defined based on a specification of the vehicle 210. For example, the threshold slope may be changed according to the specification of the vehicle 210. For example, the threshold slope may be changed according to a weight of a load of the vehicle 210.

According to an embodiment, the electronic device 101 may determine the driving path 510 based on a weight of the vehicle 210. For example, the electronic device 101 may determine the driving path 510 according to the weight of the vehicle 210 obtained via a weight sensor 140. For example, the electronic device 101 may define the threshold slope according to the weight of the vehicle 210. For example, the electronic device 101 may determine the driving path 510 to bypass the ground area, based on the slope of the ground area identified as above the defined threshold slope.

According to an embodiment, the electronic device 101 may determine the driving path 510 based on the obstacle 260 included in the image 401. For example, the electronic device 101 may identify the obstacle 260 via the depth map 501. For example, by using depth information and coordinates of pixels of an object in the image 401, the electronic device 101 may determine whether the object corresponds to the obstacle 260. For example, the electronic device 101 may determine the driving path 510 such that the vehicle 210 does not pass through the object identified as the obstacle 260.

According to an embodiment, the electronic device 101 may determine the driving path 510 based on a state (e.g., a type and/or roughness) of the ground area included in the image 401. For example, the electronic device 101 may identify the state of the ground area via the depth map 501. For example, the state of the ground area may be identified according to a degree of dispersion of depth information of the ground area. For example, the electronic device 101 may determine the driving path 510 such that it does not pass through a ground area including a plurality of irregularities.

In operation 340, the electronic device 101 may generate a control signal for controlling the vehicle 210. For example, the electronic device 101 may generate the control signal for controlling the vehicle 210 according to the driving path 510 and may transmit the control signal to the vehicle 210.

Through the operations of FIG. 3 for determining the driving path 510 via the depth map 501 of the electronic device 101, the vehicle 210 positioned in the area 250 outside the paved road 230 may perform autonomous driving. For example, the electronic device 101 may control the vehicle 210 through the operations of FIG. 3 such that it may perform autonomous driving even in an area having no paved road 230 or no road boundary.

A method of performing autonomously driving according to the driving path 510 determined by the depth map 501 may not require a guide wire buried in the ground and may require relatively low installation cost and maintenance cost.

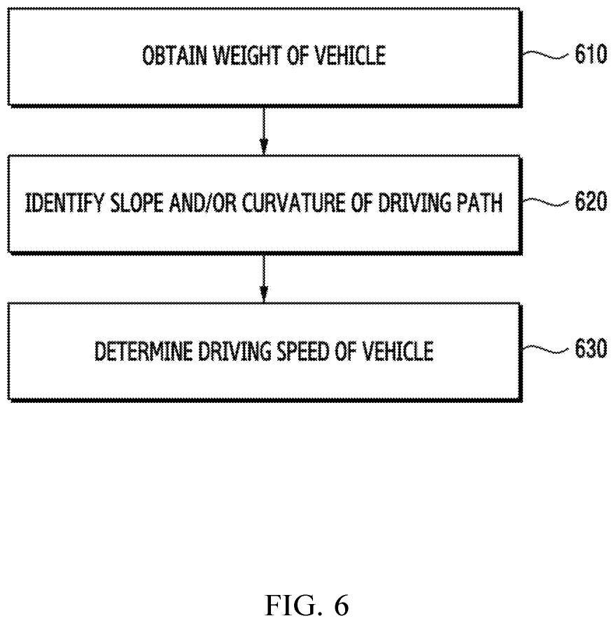

The area 250 outside the paved road 230 may include relatively many irregularities compared with the paved road 230. The area 250 outside the paved road 230 may include a ground area having a relatively high slope. When driving in the area 250 outside the paved road 230, a probability that a vehicle accident (e.g., rollover and/or damage) occurs may be relatively high. As a driving speed increases, the probability that the vehicle accident occurs may be high. Accordingly, the electronic device 101 may require an operation of adjusting the driving speed according to the state of the ground area. In FIG. 6, an operation of the electronic device 101 for determining a driving speed of the vehicle 210 by using the depth map 501 will be described.

FIG. 6 is a flowchart representing an operation of an electronic device for determining a driving speed of a vehicle.

Operations of FIG. 6 may be performed by the electronic device 101 and/or the at least one processor 110 of FIG. 1. The operations of FIG. 6 may be sequentially performed, but are not necessarily performed sequentially. For example, an order of the operations of FIG. 6 may be changed, and at least two operations among the operations of FIG. 6 may be performed in parallel.

In operation 610, the electronic device 101 may obtain a weight of a vehicle 210. For example, the electronic device 101 may obtain the weight of the vehicle 210 via a weight sensor 140. For example, the electronic device 101 may receive data on the weight of the vehicle 210 from the vehicle 210 via a communication interface (e.g., a communication interface 1280 of FIG. 12).

In operation 620, the electronic device 101 may identify a slope, a ground state, and/or a curvature of a driving path 510. According to an embodiment, the electronic device 101 may identify the slope of the driving path 510 by using a depth map 501. For example, the electronic device 101 may identify the slope of the driving path 510 via depth information (or a depth gradient) of pixels corresponding to the driving path 510. For example, the electronic device 101 may determine whether the driving path 510 is uphill or downhill by using the depth map 501.

According to an embodiment, the electronic device 101 may identify a state of ground included in the driving path 510 by using the depth map 501. For example, the electronic device 101 may identify the state of the ground included in the driving path 510 via the depth information of the pixels corresponding to the driving path 510. For example, the electronic device 101 may identify a type (e.g., a gravel field, a lawn, and/or a dirt road) of the ground and roughness (e.g., a frequency of an irregularity) of the ground by using the depth map 501.

According to an embodiment, the electronic device 101 may identify the curvature of the driving path 510 by using the depth map 501. For example, the electronic device 101 may identify the curvature of the driving path 510 according to a shape of the driving path 510 determined by the depth map 501. For example, the electronic device 101 may approximate the shape of the driving path 510 as a mathematical model and may identify the curvature of the driving path 510 by using a curve equation corresponding to the mathematical model. For example, the electronic device 101 may identify a portion of the driving path 510 as a sharp curve section based on a curvature of the portion of the driving path 510 identified as above a threshold curvature.

In operation 630, the electronic device 101 may determine a driving speed of the vehicle 210. For example, the electronic device 101 may determine the driving speed of the vehicle 210 based on the slope of the driving path 510, the state of the ground included in the driving path 510, and/or the curvature of the driving path 510.

According to an embodiment, the electronic device 101 may determine the driving speed of the vehicle 210 based on the slope of the driving path 510 and the weight of the vehicle 210. For example, as a downward slope of the driving path 510 increases, the electronic device 101 may decrease the driving speed of the vehicle 210 or downwardly adjust an upper limit of the driving speed. For example, as the weight of the vehicle 210 increases, the electronic device 101 may decrease the driving speed of the vehicle 210. The electronic device 101 may generate a control signal for controlling the vehicle 210 according to the driving speed determined based on the slope of the driving path 510 and the weight of the vehicle 210.

According to an embodiment, the electronic device 101 may determine the driving speed of the vehicle 210 based on the ground state of the driving path 510. For example, when many irregularities are included in the driving path 510, the electronic device 101 may decrease the driving speed of the vehicle 210. For example, when gravel is included in the driving path 510, the electronic device 101 may decrease the driving speed of the vehicle 210. The electronic device 101 may generate a control signal for controlling the vehicle 210 according to the driving speed determined based on the ground state of the driving path 510.

According to an embodiment, the electronic device 101 may determine the driving speed of the vehicle 210 based on the curvature of the driving path 510 and the weight of the vehicle 210. For example, as the curvature of the driving path 510 increases, the electronic device 101 may decrease the driving speed of the vehicle 210 or downwardly adjust the upper limit of the driving speed. For example, as the weight of the vehicle 210 passing through the driving path 510 having a large curvature increases, the electronic device 101 may decrease the driving speed of the vehicle 210. The electronic device 101 may generate a control signal for controlling the vehicle 210 according to the driving speed determined based on the curvature of the driving path 510 and the weight of the vehicle 210.

Through the operations of FIG. 6 of the electronic device 101 for determining the driving speed, an accident occurrence probability of the vehicle 210 autonomously driving in an area 250 outside a paved road 230 may be lowered. For example, the electronic device 101 may prevent an accident of the vehicle 210 by adjusting the driving speed in real time according to the slope, the ground state, and/or the curvature of the driving path 510.

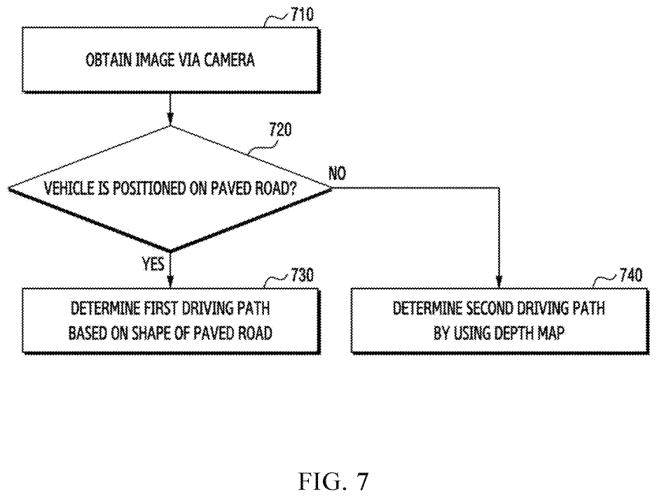

An example of an operation of the electronic device 101 in which a method for determining a driving path is changed according to whether the vehicle 210 is positioned on the paved road 230 will be described with reference to FIGS. 7 to 9.

FIG. 7 is a flowchart representing an operation of an electronic device for determining a driving path of a vehicle according to an embodiment.

Operations of FIG. 7 may be performed by the electronic device 101 and/or the at least one processor 110 of FIG. 1. The operations of FIG. 7 may be sequentially performed, but are not necessarily performed sequentially. For example, an order of the operations of FIG. 7 may be changed, and at least two operations among the operations of FIG. 7 may be performed in parallel.

In operation 710, the electronic device 101 may obtain an image via a camera 130. For example, the electronic device 101 may obtain the image via the camera 130 capturing a front of the vehicle 210. For example, the electronic device 101 may obtain, in real time, the image via the camera 130 while the vehicle 210 is driving. The image may include a frame image included in a video obtained by the camera 130. However, the present disclosure is not limited thereto. For example, the electronic device 101 may receive, via a communication interface (e.g., a communication interface 1280 of FIG. 12), an image obtained by a camera (not illustrated) included in the vehicle 210. The operation 710 may be referred to as the operation 310 of FIG. 3.

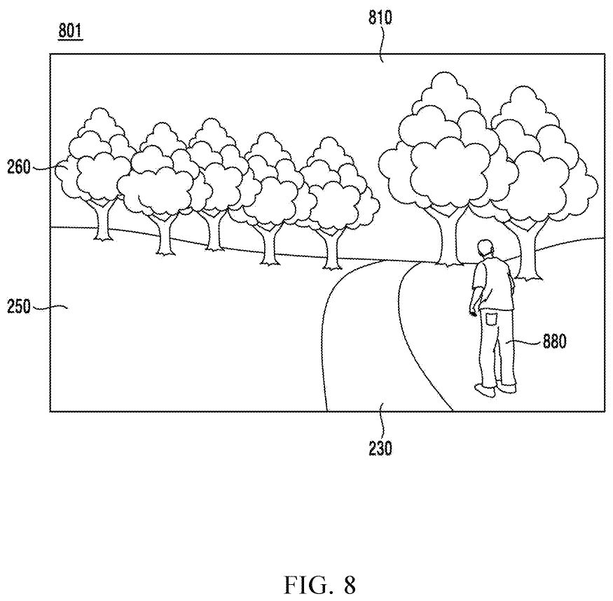

FIG. 8 illustrates an image including a road obtained by a camera according to an embodiment.

Referring to FIG. 8, an image 801 may be described as an example of an image obtained by a camera 130 of an electronic device 101. According to an embodiment, the image 801 may be described as an image capturing a front of a vehicle 210 positioned on a paved road 230. As a non-limiting example, the image 801 may include a paved road 230, an area 250 outside the paved road 230, an obstacle 260, a background object 810, and/or a pedestrian 880 (or a user).

Referring again to FIG. 7, in operation 720, the electronic device 101 may determine whether the vehicle 210 is positioned on the paved road 230. For example, the electronic device 101 may determine whether the vehicle 210 is positioned on the paved road 230 by using the image 801 obtained via the camera 130. For example, the electronic device 101 may determine whether the vehicle 210 is positioned on the paved road 230 by inputting the image 801 to an artificial intelligence model. For example, the artificial intelligence model may include a trained model for identifying an external object included in the image 801.

According to an embodiment, the electronic device 101 may identify an external object included in the image 801 by using an image segmentation technique. For example, the image segmentation technique may be described as a technique for identifying a type of an external object (or an area occupied by the external object) by separating pixels of the external object included in an image (or a video). For example, the image segmentation technique may include a semantic segmentation technique and/or a panoptic segmentation technique. For example, the electronic device 101 may perform the image segmentation technique by using an artificial intelligence model. For example, the electronic device 101 may identify or determine a type of the external object corresponding to the external object included in the image 801 by performing the image segmentation technique on the image 801 (or a video). From the artificial intelligence model trained to perform the image segmentation technique, the electronic device 101 may obtain or identify an external object (e.g., the paved road 230, the obstacle 260, and/or the pedestrian 880) corresponding to pixels of the image 801.

According to an embodiment, the electronic device 101 may determine that the vehicle 210 is positioned on the paved road 230, based on an object corresponding to the paved road 230 being included in external objects classified by the image segmentation technique. For example, the electronic device 101 may determine that the vehicle 210 is positioned on the paved road 230, based on coordinates in the image 801 of the object corresponding to the paved road 230.

According to an embodiment, the electronic device 101 may determine that the vehicle 210 is not positioned on the paved road 230, based on the object corresponding to the paved road 230 not being included in the external objects classified via the image segmentation technique. For example, even when the object corresponding to the paved road 230 is included in the image, the electronic device 101 may determine that the vehicle 210 is positioned off the paved road 230, based on a distance from the camera 130 to the object exceeding a threshold distance.

FIG. 9 illustrates an image including a classified object according to an embodiment.

Referring to FIG. 9, an image 901 in which external objects are classified is illustrated. For example, the electronic device 101 may classify external objects in the image 801 of FIG. 8. For example, the electronic device 101 may classify the external objects in the image 801 according to a type. The image 901 may be referred to as a segmentation map.

According to an embodiment, the electronic device 101 may identify types of the external objects in the image 801. For example, by performing the image segmentation technique on the image 801, the electronic device 101 may identify the external objects (e.g., the background object 810, the paved road 230, the area 250 outside the paved road 230, the obstacle 260, and/or the pedestrian 880) included in the image 801.

According to an embodiment, the electronic device 101 may identify a plurality of areas 910, 930, 950, 960, and 980 in which the image 901 is divided according to a type of external objects. For example, external objects of the same type may be included in the same area. For example, the image 901 may include a first area 910 corresponding to a background object in the image 801. For example, the image 901 may include a second area 930 corresponding to the paved road 230. For example, the image 901 may include a third area 950 corresponding to the area 250 outside the paved road 230. For example, the image 901 may include a fourth area 960 corresponding to the obstacle 260. For example, the image 901 may include a fifth area 980 corresponding to the pedestrian 880.

Referring again to FIG. 7, in response to the vehicle 210 being positioned on the paved road 230 (720—Yes), in operation 730, the electronic device 101 may determine a first driving path based on a shape of the paved road 230. For example, when the vehicle 210 is positioned on the paved road 230, the electronic device 101 may determine the first driving path according to an area (e.g., the second area 930 of FIG. 9) in the image 901 corresponding to the paved road 230. For example, the electronic device 101 may determine the first driving path according to an area corresponding to the paved road 230 classified by the image segmentation technique. The electronic device 101 may generate a first control signal for controlling the vehicle 210 according to the first driving path. For example, the electronic device 101 may transmit a second control signal to the vehicle 210 such that the vehicle 210 autonomously drives along the first driving path.

In response to the vehicle 210 not being positioned on the paved road 230 (720—No), in operation 740, the electronic device 101 may determine a second driving path (e.g., the driving path 510 of FIG. 5) by using a depth map 501. For example, when the vehicle 210 is positioned off the paved road 230, the electronic device 101 may obtain the depth map 501 by inputting an image (e.g., the image 401 of FIG. 4) to the trained model and may determine the second driving path 510 of the vehicle 210 by using the depth map 501. The operation 740 may be referred to as the operation 330 of FIG. 3.

According to an embodiment, the electronic device 101 may identify a drivable area of the vehicle 210 by using the image segmentation technique. For example, the electronic device 101 may determine the second driving path 510 according to destination information and the drivable area of the vehicle 210. For example, the electronic device 101 may identify an area (e.g., the fourth area 960 of FIG. 9) of an external object corresponding to the obstacle 260 via the image segmentation technique. The electronic device 101 may determine the second driving path 510 such that it does not pass through the fourth area 960 identified as the obstacle 260.

According to an embodiment, the electronic device 101 may generate a second control signal for controlling the vehicle 210 according to the second driving path 510. For example, the electronic device 101 may transmit the second control signal to the vehicle 210 such that the vehicle 210 autonomously drives along the second driving path 510.

According to an embodiment, the electronic device 101 may determine the driving path 510 by another operation other than the operations described in FIGS. 3 and 7. For example, the electronic device 101 may identify a person (e.g., the pedestrian 880 of FIG. 8) included in an image 801. For example, the electronic device 101 may identify the pedestrian 880 positioned in an adjacent area (e.g., a front) of the vehicle 210. The electronic device 101 may determine a driving path for following the pedestrian 880. For example, the electronic device 101 may determine a driving path connected from the vehicle 210 to a position of the pedestrian 880. For example, the electronic device 101 may identify a walking path of the pedestrian 880 by using a plurality of frame images included in a video and may determine a driving path aligned with the walking path.

For example, the electronic device 101 may generate a control signal for controlling the vehicle 210 according to the driving path 510 to the person aligned with the walking path such that the vehicle 210 may follow the person. For example, the electronic device 101 may transmit the control signal to the vehicle 210 such that the vehicle 210 autonomously drives following the person.

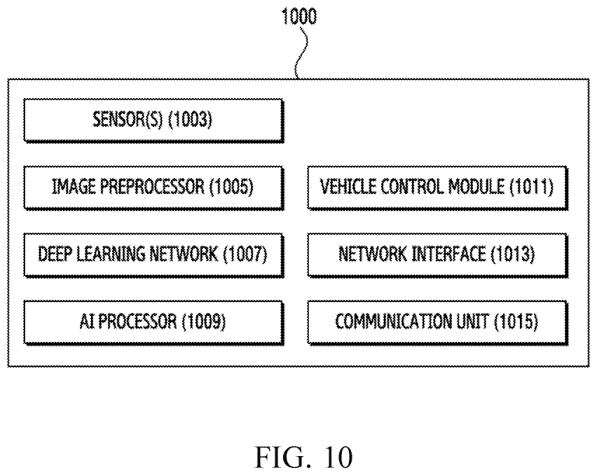

FIG. 10 illustrates an example of a block diagram illustrating an autonomous driving system of a vehicle according to an embodiment.

The autonomous driving system 1000 of the vehicle according to FIG. 10 may be a deep learning network including sensors 1003, an image pre-processor 1005, a deep learning network 1007, an artificial intelligence (AI) processor 1009, a vehicle control module 1011, a network interface 1013, and a communication unit 1015. In various embodiments, each of elements may be connected through various interfaces. For example, sensor data sensed and outputted by the sensors 1003 may be fed to the image pre-processor 1005. The sensor data processed by the image pre-processor 1005 may be fed to the deep learning network 1007 run on the AI processor 1009. An output of the deep learning network 1007 run by the AI processor 1009 may be fed to the vehicle control module 1011. Intermediate results of the deep learning network 1007 run on the AI processor 1009 may be fed to the AI processor 1009. In various embodiments, the network interface 1013 delivers autonomous driving route information and/or autonomous driving control commands for autonomous driving of the vehicle to internal block configurations, by performing communication with an electronic device (e.g., the electronic device 101 of FIG. 1) in the vehicle. In an embodiment, the network interface 1013 may be used to transmit the sensor data obtained through the sensor(s) 1003 to an external server. In some embodiments, the autonomous driving control system 1000 may include additional or fewer components as appropriate. For example, in some embodiments, the image pre-processor 1005 may be an optional component. For another example, a post-processing component (not illustrated) may be included in the autonomous driving control system 1000 to perform post-processing on the output of the deep learning network 1007 before the output is provided to the vehicle control module 1011.

In some embodiments, the sensors 1003 may include one or more sensors. In various embodiments, the sensors 1003 may be attached to different locations of the vehicle. The sensors 1003 may face one or more different directions. For example, the sensors 1003 may be attached to a front, sides, a rear, and/or a roof of the vehicle to face directions such as forward-facing, rear-facing, and side-facing. In some embodiments, the sensors 1003 may be image sensors such as high dynamic range cameras. In some embodiments, the sensors 1003 include non-visual sensors. In some embodiments, the sensors 1003 include RADAR, Light Detection And Ranging (LiDAR), and/or ultrasonic sensors in addition to an image sensor. In some embodiments, the sensors 1003 are not mounted on a vehicle having the vehicle control module 1011. For example, the sensors 1003 may be included as a portion of a deep learning system for capturing the sensor data and may be attached to an environment or a roadway and/or mounted on nearby vehicles.

In some embodiments, the image pre-processor 1005 may be used to pre-process the sensor data of the sensors 1003. For example, the image pre-processor 1005 may be used to preprocess the sensor data, to split the sensor data into one or more components, and/or to post-process one or more components. In some embodiments, the image pre-processor 1005 may be a graphics processing unit (GPU), a central processing unit (CPU), an image signal processor, or a specialized image processor. In various embodiments, the image pre-processor 1005 may be a tone-mapper processor for processing high dynamic range data. In some embodiments, the image pre-processor 1005 may be a component of the AI processor 1009.

In some embodiments, the deep learning network 1007 may be a deep learning network for implementing control commands for controlling an autonomous vehicle. For example, the deep learning network 1007 may be an artificial neural network such as a Convolutional Neural Network (CNN) trained by using the sensor data, and the output of the deep learning network 1007 is provided to the vehicle control module 1011.

In some embodiments, the artificial intelligence (AI) processor 1009 may be a hardware processor for running the deep learning network 1007. In some embodiments, the AI processor 1009 is a specialized AI processor for performing inference on the sensor data through the Convolutional Neural Network (CNN). In some embodiments, the AI processor 1009 may be optimized for a bit depth of the sensor data. In some embodiments, the AI processor 1009 may be optimized for deep learning computations, such as computations of a neural network including a convolution, a dot product, a vector and/or matrix computations. In some embodiments, the AI processor 1009 may be implemented through a plurality of graphics processing units (GPUs) capable of effectively performing parallel processing.

In various embodiments, the AI processor 1009 may be coupled, through an input/output interface, to memory configured to perform a deep learning analysis on the sensor data received from the sensor(s) 1003 while the AI processor 1009 is running and to provide an AI processor having commands that cause to determine a machine learning result used to operate the vehicle at least partially autonomously. In some embodiments, the vehicle control module 1011 may be used to process commands for vehicle control outputted from the artificial intelligence (AI) processor 1009 and translate the output of the AI processor 1009 into commands for controlling a module of each vehicle to control various modules of the vehicle. In some embodiments, the vehicle control module 1011 is used to control a vehicle for autonomous driving. In some embodiments, the vehicle control module 1011 may adjust steering and/or speed of the vehicle. For example, the vehicle control module 1011 may be used to control traveling of the vehicle such as deceleration, acceleration, steering, lane change, lane keeping, and the like. In some embodiments, the vehicle control module 1011 may generate control signals for controlling vehicle lighting, such as brake lights, turns signals, headlights, and the like. In some embodiments, the vehicle control module 1011 may be used to control vehicle audio-related systems such as a vehicle's sound system, vehicle's audio warnings, a vehicle's microphone system, a vehicle's horn system, and the like.

In some embodiments, the vehicle control module 1011 may be used to control notification systems, including warning systems to notify passengers and/or a driver of driving events, such as approach of an intended destination or a potential collision. In some embodiments, the vehicle control module 1011 may be used to adjust sensors, such as the sensors 1003 of the vehicle. For example, the vehicle control module 1011 may modify the orientation of the sensors 1003, change output resolution and/or a format type of the sensors 1003, increase or decrease a capture rate, adjust a dynamic range, and adjust a focus of the camera. In addition, the vehicle control module 1011 may turn on/off the operation of sensors individually or collectively.

In some embodiments, the vehicle control module 1011 may be used to change parameters of the image pre-processor 1005 in a method such as modifying a frequency range of filters, adjusting features and/or edge detection parameters for object detection, or adjusting channels and a bit depth, and the like. In various embodiments, the vehicle control module 1011 may be used to control autonomous driving of the vehicle and/or a driver assistance function of the vehicle.

In some embodiments, the network interface 1013 may be responsible for an internal interface between block configurations of the autonomous driving control system 1000 and the communication unit 1015. Specifically, the network interface 1013 may be a communication interface for receiving and/or transmitting data including voice data. According to various embodiments, the network interface 1013 may be connected to external servers to connect voice calls, receive and/or transmit text messages, transmit sensor data, update software of the vehicle with the autonomous driving system, or update software of the autonomous driving system of the vehicle, through the communication unit 1015.

In various embodiments, the communication unit 1015 may include various wireless interfaces of cellular or WiFi methods. For example, the network interface 1013 may be used to receive an update on operating parameters and/or commands for the sensors 1003, the image pre-processor 1005, the deep learning network 1007, the AI processor 1009, and the vehicle control module 1011 from an external server connected through the communication unit 1015. For example, a machine learning model of the deep learning network 1007 may be updated by using the communication unit 1015. According to another example, the communication unit 1015 may be used to update operating parameters of the image pre-processor 1005, such as image processing parameters, and/or firmware of the sensors 1003.

In another embodiment, the communication unit 1015 may be used to activate communications for an emergency contact and emergency services in an accident or near-accident event. For example, in a crash event, the communication unit 1015 may be used to call emergency services for assistance and may be used to externally notify emergency services of crash details and a location of the vehicle. In various embodiments, the communication unit 1015 may update or obtain an expected arrival time and/or a destination location.

According to an embodiment, the autonomous driving system 1000 illustrated in FIG. 10 may be configured with an electronic device 101 of the vehicle. According to an embodiment, when an autonomous driving release event occurs from a user during autonomous driving of the vehicle, the AI processor 1009 of the autonomous driving system 1000 may control the software of the vehicle autonomous driving to learn by controlling information related to the autonomous driving release event to be inputted as training set data of the deep learning network.

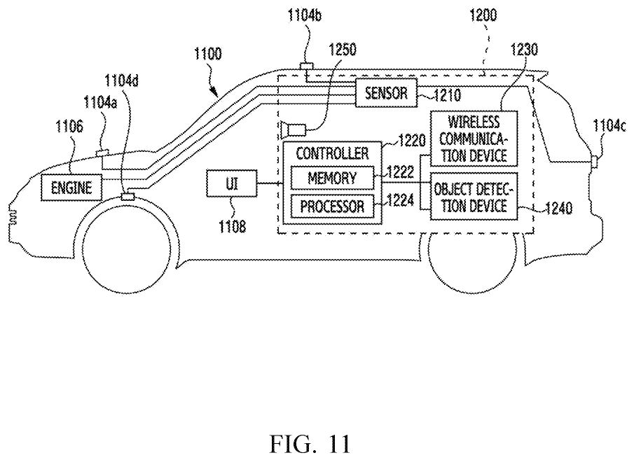

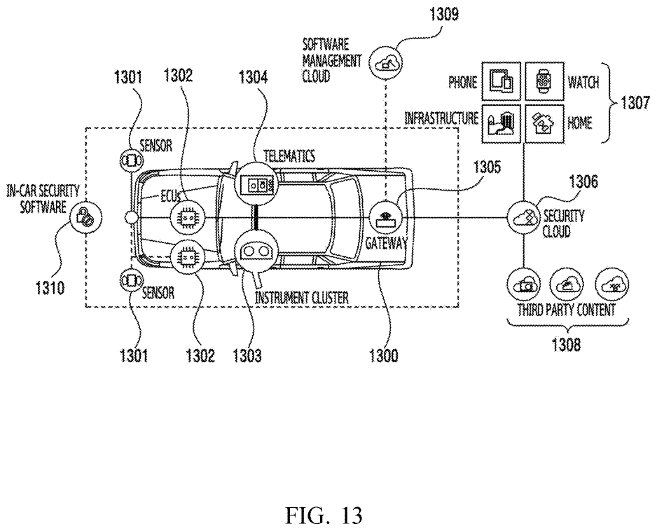

FIGS. 11 and 12 illustrate an example of a block diagram indicating an autonomous driving moving object according to an embodiment. FIG. 13 illustrates an example of a gateway related to a user device according to various embodiments.

Referring to FIG. 11, an autonomous driving moving object 1100 according to the present embodiment may include a control device 1150, sensing modules 1104a, 1104b, 1104c, and 1104d, an engine 1106, and a user interface 1108.

The autonomous driving moving object 1100 may have an autonomous driving mode or a manual mode. As an example, according to a user input received through the user interface 1108, it may be switched from the manual mode to the autonomous driving mode or may be switched from the autonomous driving mode to the manual mode.

In case that the moving object 1100 operates in the autonomous driving mode, the autonomous driving moving object 1100 may operate under control of the control device 1150.

In the present embodiment, the control device 1150 may include a controller 1220, including memory 1222 and a processor 1224, a sensor 1210, a communication device 1230, and an object detection device 1240.

Herein, the object detection device 1240 may perform all or a portion of a function of a distance measurement device.

That is, in the present embodiment, the object detection device 1240 is a device for detecting an object located outside the moving object 1100, and the object detection device 1240 may detect the object located outside the moving object 1100 and generate object information according to the detection result.

The object information may include information on existence or nonexistence of the object, location information of the object, distance information between the moving object and the object, and relative speed information between the moving object and the object.

The object may include various objects located outside the moving object 1100, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 1240 may include a camera module. The controller 1220 may extract object information from an external image captured by the camera module and enable the controller 1220 to process information thereon.

In addition, the object detection device 1240 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 1100 and the object, and may control an operation of the moving object based on the distance calculated in connection with the control device 1150 of the autonomous driving moving object 1100.

As an example, in case that there is a probability of a collision according to the distance between the autonomous driving moving object 1100 and the object, the autonomous driving moving object 1100 may control a brake to lower a speed or stop. As another example, in case that the object is a moving object, the autonomous driving moving object 1100 may control a traveling speed of the autonomous driving moving object 1100 to maintain a predetermined distance or more from the object.

This distance measurement device according to an embodiment of the present invention may be configured as a module in the control device 1150 of the autonomous driving moving object 1100. That is, the memory 1222 and the processor 1224 of the control device 1150 may be configured to implement a collision prevention method according to the present invention in software.

In addition, the sensor 1210 may obtain various sensing information by connecting an internal/external environment of the moving object with the sensing modules 1104a, 1104b, 1104c, and 1104d. Herein, the sensor 1210 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 1210 may obtain sensing signals for moving object posture information, moving object collision information, moving object direction information, moving object location information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 1210 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 1210 may generate moving object state information based on sensing data.

The wireless communication device 1230 is configured to implement wireless communication between the autonomous driving moving object 1100. For example, it enables the autonomous driving moving object 1100 to communicate with a mobile phone of a user, or the other wireless communication device 1230, another moving object, a central device (a traffic control device), a server, and the like. The wireless communication device 1230 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 1100 to implement communication between moving objects through the wireless communication device 1230. That is, the wireless communication device 1230 may perform communication with another moving object and other moving objects on the road through vehicle-to-vehicle (V2V) communication. The autonomous driving moving object 1100 may transmit and receive information such as driving warning and traffic information through the vehicle-to-vehicle (V2V) communication, and it is also possible to request information from, or receive a request from the other moving object. For example, the wireless communication device 1230 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 1230.

In addition, the wireless communication device 1230 may obtain information generated from various mobilities, including infrastructure (a traffic light, a CCTV, a RSU, a eNode B, and the like) located on the road or other autonomous driving/non-autonomous driving vehicles, and the like, through a non-terrestrial network other than a terrestrial network, as information for autonomous driving performance of the autonomous driving moving object 1100.

For example, the wireless communication device 1230 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 1100.

For example, the wireless communication device 1230 may perform wireless communication with various platforms configuring the NTN according to wireless access specifications of a 5TH Generation New Radio Non-Terrestrial Network (5G NR NTN) standard, which is currently discussed in 3GPP, and the like, but is not limited thereto.

In the present embodiment, the controller 1220 may select a platform that may properly perform NTN communication in consideration of various information such as a location of the autonomous driving moving object 1100, current time, and available power, and control the wireless communication device 1230 to perform wireless communication with the selected platform.

In the present embodiment, the controller 1220, which is a unit that controls an overall operation of each unit in the moving object 1100, may be configured by a manufacturer of the moving object when manufacturing or may be additionally configured to perform a function of autonomous driving after manufacturing. In addition, a configuration for performing a continuous additional function may be included through an upgrade of the controller 1220 configured when manufacturing. This controller 1220 may also be named an Electronic Control Unit (ECU).

The controller 1220 may collect various data from the connected sensor 1210, the object detection device 1240, the communication device 1230, and may transmit a control signal to the sensor 1210, the engine 1106, the user interface 1108, the communication device 1230, and the object detection device 1240 included in other components in the moving object based on the collected data. In addition, although not illustrated, the control signal may also be transmitted to an acceleration device, a braking system, a steering device, or a navigation device related to traveling of the moving object.

In the present embodiment, the controller 1220 may control the engine 1106, for example, may detect a speed limit of a road on which the autonomous driving moving object 1100 is traveling, and may control the engine 1106 so that a traveling speed does not exceed the speed limit or may control the engine 1106 to accelerate the traveling speed of the autonomous driving moving object 1100 in a range that does not exceed the speed limit.

In addition, when the autonomous driving moving object 1100 approaches a lane or leaves the lane while the autonomous driving moving object 1100 is traveling, the controller 1220 may determine whether such lane approaching and leaving are due to a normal traveling situation or another traveling situation, and may control the engine 1106 to control the traveling of the moving object according to the determination result. Specifically, the autonomous driving moving object 1100 may detect lanes formed on both sides of the lane in which the moving object is traveling. In this case, the controller 1220 may determine whether the autonomous driving moving object 1100 approaches the lane or leaves the lane, and if it is determined that the autonomous driving moving object 1100 approaches the lane or leaves the lane, the controller 1220 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 1100 is approaching the lane or leaving the lane in a situation in which the moving object does not need to change lane, the controller 1220 may control the traveling of the autonomous driving moving object 1100 so that the autonomous driving moving object 1100 does not leave the lane and normally travels in a corresponding vehicle.

In case that another moving object or an obstacle exists in a front of the moving object, it may control the engine 1106 or the braking system to decelerate the driving moving object, and may control a trajectory, a traveling route, and a steering angle in addition to speed. Alternatively, the controller 1220 may control the traveling of the moving object by generating a necessary control signal according to recognition information of another external environment, such as a traveling lane or a driving signal of the moving object.

In addition to generating its own control signal, the controller 1220 may also control the traveling of the moving object by performing communication with a nearby moving object or a central server and transmitting a command to control peripheral devices through the received information.

In addition, since accurate recognition of the moving object or lane according to the present embodiment may be difficult in case that a location of the camera module 1250 changes or an angle of view changes, the controller 1220 may generate a control signal for controlling to perform calibration of the camera module 1250 to prevent this. Therefore, in the present embodiment, by generating the calibration control signal to the camera module 1250, the controller 1220 may continuously maintain a normal mounting location, a direction, an angle of view, and the like of the camera module 1250 even when a mounting location of the camera module 1250 is changed due to vibration or impact generated by a movement of the autonomous driving moving object 1100. In case that an initial mounting location, a direction, and an angle of view information of the camera module 1250 that are pre-stored, and an initial mounting location, a direction, an angle of view information, and the like of the camera module 1250 measured while the autonomous driving moving object 1100 is traveling are changed by a threshold value or more, the controller 1220 may generate the control signal to perform the calibration of the camera module 1250.

In the present embodiment, the controller 1220 may include the memory 1222 and the processor 1224. The processor 1224 may execute software stored in the memory 1222 according to the control signal of the controller 1220. Specifically, the controller 1220 may store data and commands for performing the lane detection method according to the present invention in the memory 1222, and the commands may be executed by the processor 1224 to implement one or more methods disclosed herein.

In this case, the memory 1222 may be a non-volatile recording medium executable by the processor 1224. The memory 1222 may store software and data through an appropriate internal/external device. The memory 1222 may be configured with random access memory (RAM), read only memory (ROM), a hard disk, and a memory 1222 device connected with a dongle.

The memory 1222 may at least store an Operating system (OS), a user application, and executable commands. The memory 1222 may also store application data and array data structures.

The processor 1224, which is a microprocessor or an appropriate electronic processor, may be a controller, a microcontroller, or a state machine.

The processor 1224 may be implemented as a combination of computing devices, and the computing device may be configured with a digital signal processor, a microprocessor, or an appropriate combination thereof.

Meanwhile, the autonomous driving moving object 1100 may further include the user interface 1108 for a user input with respect to the above-described control device 1150. The user interface 1108 may enable a user to input information with appropriate interaction. For example, it may be implemented as a touch screen, a keypad, or an operation button, and the like. The user interface 1108 may transmit an input or a command to the controller 1220, and the controller 1220 may perform a control operation of the moving object in response to the input or the command.

In addition, the user interface 1108, which is a device outside the autonomous driving moving object 1100, may perform communication with the autonomous driving moving object 1100 through the wireless communication device 1230. For example, the user interface 1108 may be linkable with a mobile phone, a tablet, or another computer device.

Furthermore, in the present embodiment, the autonomous driving moving object 1100 has been described as including the engine 1106, but it may also include another type of a propulsion system. For example, the moving object may be operated with electrical energy, and may be operated through hydrogen energy or a hybrid system combining them. Therefore, the controller 1220 may include a propulsion mechanism according to the propulsion system of the autonomous driving moving object 1100 and may provide a control signal according to this to components of each propulsion mechanism.

Hereinafter, a detailed configuration of the control device 1150 according to the present invention according to the present embodiment will be described in more detail with reference to FIG. 12.

A control device 1150 includes a processor 1224. The processor 1224 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 1224 is used as a combination of a plurality of processors.

The control device 1150 also includes memory 1222. The memory 1222 may be any electronic component capable of storing electronic information. The memory 1222 may also include a combination of the memories 1222 in addition to single memory.

Data 1222b and commands 1222a for performing a distance measuring method of a distance measuring device according to the present invention may be stored in the memory 1222. When the processor 1224 executes the commands 1222a, all or a portion of the commands 1224a and the data 1224b required for performing a command may be loaded onto the processor 1224.

The control device 1150 may include a transmitter 1230a, a receiver 1230b, or a transceiver 1230c for permitting transmission and reception of signals. One or more antennas 1232a and 1232b may be electrically connected to the transmitter 1230a, the receiver 1230b, or each transceiver 1230c, and may further include antennas.

The control device 1150 may include a digital signal processor (DSP) 1270. Through the DSP 1270, the digital signal may be quickly processed by a moving object.

The control device 1150 may include a communication interface 1280. The communication interface 1280 may include one or more ports and/or communication modules for connecting other devices to the control device 1150. The communication interface 1280 may enable a user and the control device 1150 to interact with each other.

Various configurations of the control device 1150 may be connected together by one or more buses 1290, and the buses 1290 may include a power bus, a control signal bus, a state signal bus, a data bus, and the like. Under a control of the processor 1224, configurations may transmit mutual information through the bus 1290 and perform a desired function.

Meanwhile, in various embodiments, the control device 1150 may be related to a gateway for communication with a security cloud. For example, referring to FIG. 13, the control device 1150 may be related to a gateway 1305 for providing information obtained from at least one of components 1001 to 1004 of a vehicle 1300 to a security cloud 1306. For example, the gateway 1305 may be included in the control device 1150. For another example, the gateway 1305 may be configured as a separate device in the vehicle 1300 that is distinguished from the control device 1150. The gateway 1305 connects a network in the vehicle 1300 secured by a software management cloud 1309, the security cloud 1306, and in-car security software 1310, having different networks, to enable communication.

For example, a component 1301 may be a sensor. For example, the sensor may be used to obtain information on at least one of a state of the vehicle 1300 or a state around the vehicle 1300. For example, the component 1301 may include a sensor 1210.

For example, a component 1302 may be electronic control units (ECUs). For example, the ECUs may be used for engine control, transmission control, airbag control, and tire pressure management.

For example, a component 1303 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1300, visual elements for indicating an amount of remaining fuel, visual elements for indicating a state of a gear, or visual elements for indicating information obtained through the component 1301.

For example, a component 1304 may be a telematics device. For example, the telematics device may mean a device that provides various mobile communication services, such as location information and safe driving in the vehicle 1300 by coupling wireless communication technology and global positioning system (GPS) technology. For example, the telematics device may be used to connect the vehicle 1300 with a driver, a cloud (e.g., the security cloud 1306), and/or a surrounding environment. For example, the telematics device may be configured to support high bandwidth and low latency for 5G NR-standard technology (e.g., V 2X technology of the 5G NR, Non-Terrestrial Network (NTN) technology of the 5G NR). For example, the telematics device may be configured to support autonomous driving of the vehicle 1300.

For example, the gateway 1305 may be used to connect a network within the vehicle 1300, and the software management cloud 1309 and the secure cloud 1306, which are a network outside the vehicle. For example, the software management cloud 1309 may be used to update or manage at least one software necessary for traveling and managing the vehicle 1300. For example, the software management cloud 1309 may be linked to the in-car security software 1310 installed in the vehicle. For example, the in-car security software 1310 may be used to provide a security function in the vehicle 1300. For example, the in-car security software 1310 may encrypt data transmitted and received through an in-car network using an encryption key obtained from an external authorized server for encryption of the in-car network. In various embodiments, the encryption key used by the in-car security software 1310 may be generated corresponding to vehicle identification information (a vehicle license plate, a vehicle identification number (VIN)) or information (e.g., user identification information) uniquely assigned to each user.

In various embodiments, the gateway 1305 may transmit the data encrypted by the in-car security software 1310 based on the encryption key to the software management cloud 1309 and/or the security cloud 1306. The software management cloud 1309 and/or the security cloud 1306 may identify the data received from which vehicle or which user by decrypting the data encrypted by the encryption key of the in-car security software 1310. For example, since the decryption key is a unique key corresponding to the encryption key, the software management cloud 1309 and/or the security cloud 1306 may identify a transmission entity (e.g., the vehicle or the user) of the data based on the data decrypted through the decryption key.

For example, the gateway 1305 may be configured to support in-car security software 1310 and may be related to the control device 1150. For example, the gateway 1305 may be related to the control device 1150 to support a connection between a client device 1307 and the control device 1150 connected to the security cloud 1306. For another example, the gateway 1305 may be related to the control device 1150 to support a connection between a third-party cloud 1308 connected to the security cloud 1306 and the control device 1150. However, it is not limited thereto.

In various embodiments, the gateway 1305 may be used to connect the vehicle 1300 with the software management cloud 1309 to manage operating software of the vehicle 1300. For example, the software management cloud 1309 may monitor whether updating the operating software of the vehicle 1300 is required, and based on monitoring that the updating the operating software of the vehicle 1300 is required, provide data for the updating the operating software of the vehicle 1300 through the gateway 1305. For another example, the software management cloud 1309 may receive a user request for updating the operating software of the vehicle 1300 from the vehicle 1300 through the gateway 1305, and provide data for updating the operating software of the vehicle 1300 based on the reception. However, it is not limited thereto.

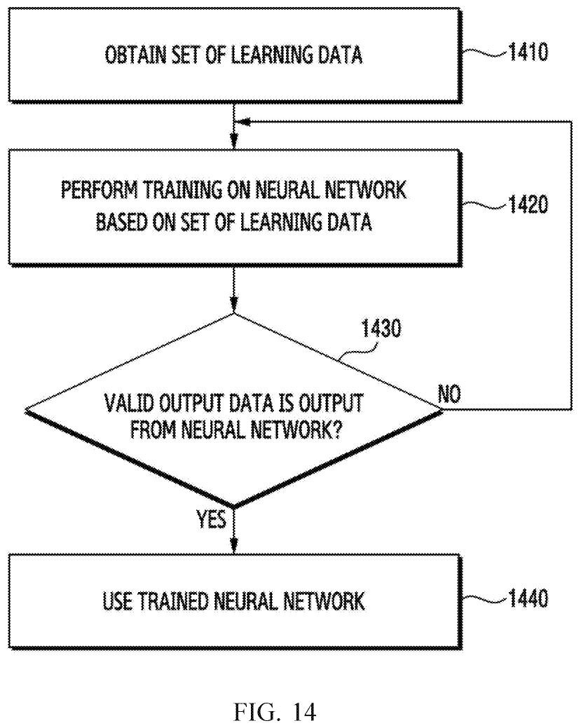

FIG. 14 is a diagram for explaining an operation of an electronic device for training a neural network based on a set of learning data, according to an embodiment.

An operation described with reference to FIG. 14 may be performed by the above-described electronic device (e.g., the electronic device 101 of FIG. 1).

Referring to FIG. 14, in operation 1410, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1410 may include pairs of a plurality of learning data. In the example of training the neural network for the image recognition, the set of the learning data identified by the electronic device may include a plurality of images and ground truth data corresponding to each of the plurality of images.

Referring to FIG. 14, in operation 1420, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 10. From an output layer of the neural network receiving the input data through the input layer, the electronic device may obtain output data of the neural network corresponding to the input data.

In an embodiment, the training of the operation 1420 may be performed based on a difference between the output data and the ground truth data included in the learning data and corresponding to the input data. For example, the electronic device may adjust one or more parameters related to the neural network (e.g., a weight to be described later with reference to FIG. 10) to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

Referring to FIG. 14, in operation 1430, according to an embodiment, the electronic device may identify whether valid output data is outputted from the neural network trained by the operation 1420. The output data being valid may mean that the difference (or the cost function) between the output data and the ground truth data satisfies a condition set for use of the neural network. For example, in case that an average value and/or the maximum value of the difference between the output data and the ground truth data is less than or equal to a designated threshold value, the electronic device may determine that the valid output data is outputted from the neural network.

In case that the valid output data is not outputted from the neural network (1430—NO), the electronic device may repeatedly perform training of the neural network based on the operation 1420. An embodiment is not limited thereto, and the electronic device may repeatedly perform the operations 1410 and 1420.

In a state in which the valid output data is obtained from the neural network (1430—YES), based on operation 1440, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

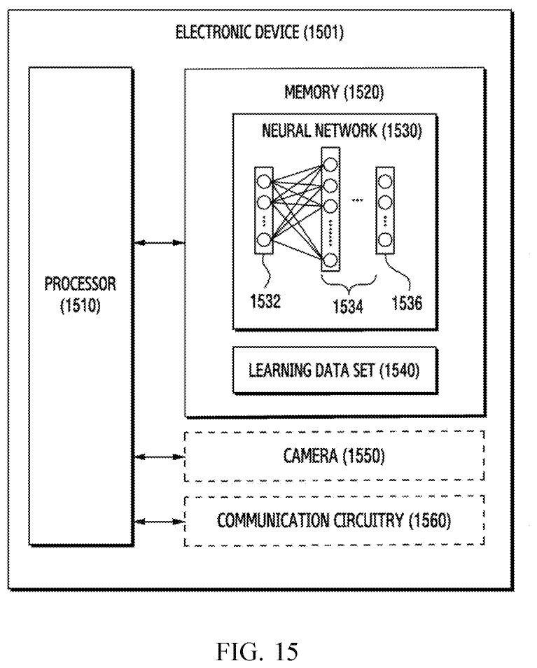

FIG. 15 is a block diagram of an electronic device according to an embodiment.

An electronic device 1501 (e.g., the electronic device 101 of FIG. 1) of FIG. 15 may include the above-described electronic device.

For example, an operation described with reference to FIG. 14 may be performed by the electronic device 1501 of FIG. 15 and/or a processor 1510 of FIG. 15.

Referring to FIG. 15, the processor 1510 of the electronic device 1501 may perform computations related to a neural network 1530 stored in memory 1520. The processor 1510 may include at least one of a center processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 15, the processor 1510 may identify the neural network 1530 stored in the memory 1520. The neural network 1530 may include a combination of an input layer 1532, one or more hidden layers 1534 (or intermediate layers), and an output layer 1536. The above-described layers (e.g., the input layer 1532, the one or more hidden layers 1534, and the output layer 1536) may include a plurality of nodes. The number of hidden layers 1534 may vary according to an embodiment, and the neural network 1530 including the plurality of hidden layers 1534 may be referred to as a deep neural network. An operation of training the deep neural network may be referred to as deep learning.

In an embodiment, in case that the neural network 1530 has a structure of a feed forward neural network, a first node included in a specific layer may be connected to all of second nodes included in another layer before the specific layer. In the memory 1520, parameters stored for the neural network 1530 may include weights assigned to connections between the second nodes and the first node. In the neural network 1530 having the structure of the feed forward neural network, a value of the first node may correspond to a weighted sum of values assigned to the second nodes, based on the weights assigned to the connections connecting the second nodes and the first node.

In an embodiment, in case that the neural network 1530 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1520, the parameters stored for the neural network 1530 may include weights indicating the filter. The filter may include, among the second nodes, one or more nodes to be used to calculate a weighted sum of the first node, and weights corresponding to each of the one or more nodes.

According to an embodiment, the processor 1510 of the electronic device 1501 may perform training on the neural network 1530 using a learning data set 1540 stored in the memory 1520. Based on the learning data set 1540, the processor 1510 may adjust one or more parameters stored in the memory 1520 for the neural network 1530 by performing the operation described with reference to FIG. 14.

According to an embodiment, the processor 1510 of the electronic device 1501 may perform object detection, object recognition, and/or object classification using the neural network 1530 trained based on the learning data set 1540. The processor 1510 may input an image (or a video) obtained through a camera 1550 into the input layer 1532 of the neural network 1530. Based on the input layer 1532 to which the image is inputted, the processor 1510 may obtain a set (e.g., the output data) of values of the nodes of the output layer 1536 by sequentially obtaining values of the nodes of the layers included in the neural network 1530. The output data may be used as a result of inferring information included in the image using the neural network 1530. An embodiment is not limited thereto, and the processor 1510 may input an image (or a video) obtained from an external electronic device connected to the electronic device 1501 through communication circuitry 1560 to the neural network 1530.

In an embodiment, the neural network 1530 trained to process an image may be used to identify a region corresponding to a subject within the image (object detection), and/or to identify a class of the subject represented within the image (object recognition and/or object classification). For example, the electronic device 1501 may segment the region corresponding to the subject within the image based on a quadrangle shape such as a bounding box, using the neural network 1530. For example, the electronic device 1501 may identify at least one class matching the subject among a plurality of designated classes using the neural network 1530.

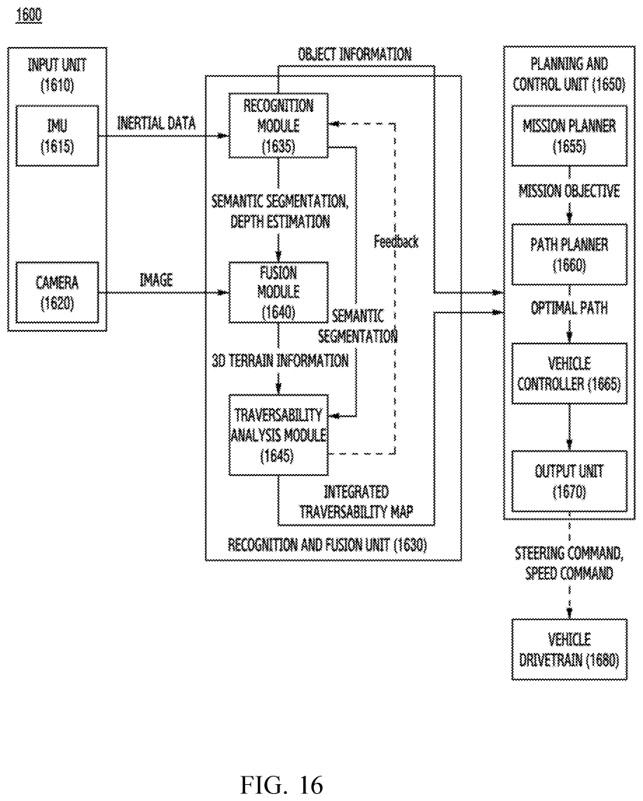

FIG. 16 is a functional block diagram of an autonomous driving system planning a driving path by using an object recognition result according to another embodiment of the present invention. An autonomous driving system 1600 illustrated in FIG. 16 may be implemented by being included in the electronic device 101 of FIG. 1, or may be implemented as a functional module embodied in the autonomous driving system 800 of FIG. 8.

Referring to FIG. 16, the autonomous driving system 1600 includes an input unit 1610, a recognition and fusion unit 1630, a planning and control unit 1650, an output unit 1670, and a vehicle drivetrain 1680. The input unit 1610 performs a role of collecting external environment information and state information of a vehicle necessary for autonomous driving. In the present embodiment, the input unit 1610 includes an Inertial Measurement Unit (IMU) 1615 and a camera 1620.

The inertial measurement unit 1615, which is a sensor for measuring inertial information of a vehicle in real time, is configured with a 3-axis accelerometer and a 3-axis gyroscope. The inertial measurement unit 1615 generates inertial data by measuring acceleration and angular velocity of a vehicle, and transmits this to the recognition and fusion unit 1630. The inertial data includes information such as a posture change (pitch, roll, or yaw), a moving speed, acceleration, and the like of a vehicle, and this is subsequently utilized to solve scale ambiguity of depth information estimated from a camera image and to correct a cumulative error.

The camera 1620 is a monocular camera obtaining an image by capturing an unpaved road environment in front of a vehicle. The camera 1620 obtains images of continuous frames and transmits them to the recognition and fusion unit 1630. The present invention has an advantage in that accurate three-dimensional environment recognition is possible only by a combination of the low-cost monocular camera 1620 and the inertial measurement unit 1615 without an expensive LiDAR or stereo camera.

The recognition and fusion unit 1630 processes inertial data and an image received from the input unit 1610, and generates integrated information on an environment in which a vehicle is capable of driving. The recognition and fusion unit 1630 includes a recognition module 1635, a fusion module 1640, and a traversability analysis module 1645.

The recognition module 1635 performs Semantic Segmentation and Depth Estimation on the image obtained from the camera 1620. The semantic segmentation may be performed by using the first artificial intelligence model or the second artificial intelligence model described in FIGS. 1 to 13, and classifies a class of an object for each pixel or area of an image. For example, it identifies various terrain elements and objects existing in an unpaved road environment, such as a dirt road, grass, a tree, a rock, a ditch, and the like. The depth estimation, which is a process of estimating a relative distance to each pixel from a monocular image, may be performed through a deep learning-based depth estimation network. The recognition module 1635 transmits a semantic segmentation result to the planning and control unit 1650 as object information, and transmits a depth estimation result to the fusion module 1640.

The fusion module 1640 generates three-dimensional terrain information by tightly coupling depth information estimated by the recognition module 1635 and inertial data received from the inertial measurement unit 1615. Specifically, by using an Extended Kalman Filter or a similar sensor fusion algorithm, it fuses movement of a vehicle estimated through the inertial data and a visual change between image frames. Through this, it may solve a Scale Ambiguity problem that is difficult to solve only with a monocular camera, and may generate accurate and consistent three-dimensional terrain information by correcting a driving distance error (Drift) accumulated over time. The generated three-dimensional terrain information includes three-dimensional coordinates and height information on terrain in front of a vehicle, and this is transmitted to the traversability analysis module 1645.

The traversability analysis module 1645 generates an integrated Traversability Map by comprehensively using the three-dimensional terrain information generated from the fusion module 1640 and the semantic segmentation result of the recognition module 1635. The integrated traversability map is a two-dimensional map that divides a space in front of a vehicle into a Grid form and allocates a driving cost to each grid cell. The driving cost is calculated by comprehensively considering a type of terrain, a slope, roughness, a Negative Obstacle, and the like. For example, a hard dirt road has a low cost, soft soil or mud has an intermediate cost, and a ditch or a pit having a risk that a vehicle may become stuck has a very high cost. In addition, an additional cost may be assigned to an area having a steep slope or an area having high roughness of the ground. The traversability analysis module 1645 transmits the generated integrated traversability map to the planning and control unit 1650. In addition, the traversability analysis module 1645 may dynamically improve accuracy of the semantic segmentation by feeding back an analysis result to the recognition module 1635 via a Feedback path indicated by a dotted line.

The planning and control unit 1650 plans an optimal driving path and generates a vehicle control command based on object information and an integrated traversability map received from the recognition and fusion unit 1630 and a mission objective (object information) input from the outside. The planning and control unit 1650 includes a mission planner 1655, a path planner 1660, and a vehicle controller 1665.

A mission objective is input to the mission planner 1655 from a user or an external system. The mission objective indicates a goal or priority of driving to be performed by a vehicle, and may be, for example, an agricultural mode, a military mode, a leisure mode, a golf cart mode, and the like. The agricultural mode may aim to minimize soil compaction of farmland, the military mode may aim to maintain a formation in extreme terrain, and the leisure mode may aim to prioritize ride comfort of an occupant. The mission planner 1655 dynamically sets a weight of a cost function to be considered when planning a path according to an input mission objective, and transmits it to the path planner 1660. The mission objective is input to the mission planner 1655 through an arrow indicated by a dotted line.

The path planner 1660 plans an optimal path by using the integrated traversability map transmitted from the traversability analysis module 1645 and the cost function weight transmitted from the mission planner 1655. The path planner 1660 searches for a path having the lowest accumulated cost among paths from a current position to a goal point by using an A* algorithm, a Rapidly-exploring Random Tree Star (RRT*) algorithm, or a similar graph search algorithm. In this case, even in the same terrain, a selected path may vary according to the mission objective. For example, in the agricultural mode, a path minimizing soil compaction is preferentially selected, and in the leisure mode, a smooth path having good ride comfort is preferentially selected. The path planner 1660 transmits the planned optimal path to the vehicle controller 1665.

The vehicle controller 1665 generates a steering command and a speed command such that a vehicle drives along the optimal path generated by the path planner 1660. The steering command is a command for controlling a steering angle of a vehicle, and the speed command is a command for controlling acceleration or deceleration of a vehicle. The vehicle controller 1665 may generate a control command such that a vehicle accurately follows the planned path by using a PID controller, a Model Predictive Control (MPC) controller, or a similar control algorithm. The generated steering command and speed command are transmitted to the output unit 1670.

The output unit 1670 transmits the steering command and the speed command received from the vehicle controller 1665 to the vehicle drivetrain 1680. The output unit 1670 may convert the control command into an appropriate electric signal or communication protocol and may transmit it in a form that the vehicle drivetrain 1680 may understand.

The vehicle drivetrain 1680 controls an actual steering angle and speed of a vehicle according to the steering command and the speed command received from the output unit 1670. The vehicle drivetrain 1680 includes a steering actuator, a drive motor, a brake system, and the like, and drives a vehicle in a desired direction and at a desired speed by controlling them.

As such, the autonomous driving system 1600 illustrated in FIG. 16 may perform accurate recognition and fusion on an unpaved road environment by using the inertial measurement unit 1615 and the monocular camera 1620, which are a low-cost sensor combination, and may safely and efficiently control a vehicle by planning a driving path dynamically optimized according to a mission objective.

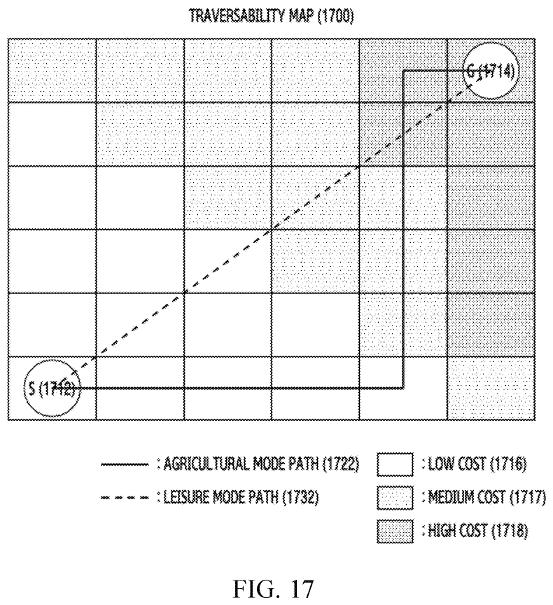

FIG. 17 is a conceptual diagram illustrating a process in which different optimal paths are generated according to a mission purpose even when having the same start point and goal point on the same traversability map, according to an embodiment of the present invention.

Referring to FIG. 17, a traversability map 1700 is a two-dimensional map representing a space in front of a vehicle in a Grid form. Each grid cell of the traversability map 1700 is divided and displayed in different patterns according to a driving cost. The driving cost is a value calculated by comprehensively considering a type of terrain, a slope, roughness, a negative obstacle, and the like by the traversability analysis module 1645 described in FIG. 16.

In the traversability map 1700, a low-cost area 1716 is displayed as an empty space having no pattern. The low-cost area 1716 indicates terrain most suitable for driving, and corresponds to, for example, a hard dirt road, flat ground, or an area having no obstacle. A medium-cost area 1717 is displayed with a diagonal pattern, and indicates terrain on which driving is possible but having a higher driving cost than the low-cost area 1716. The medium-cost area 1717 may correspond to, for example, somewhat soft soil, a gentle slope, or a lawn having low roughness, and the like. A high-cost area 1718 is displayed with a grid pattern, and indicates terrain on which driving is difficult or impossible. The high-cost area 1718 corresponds to, for example, a ditch or a pit having a risk that a vehicle may become stuck, a steep slope, an obstacle such as a rock, and the like, or an area having low driving stability such as mud.

In the traversability map 1700, a start point S 1712 and a goal point G 1714 of a vehicle are displayed. The start point 1712 is positioned at a lower left end of the traversability map 1700, and the goal point 1714 is positioned at an upper right end. The vehicle should depart from the start point 1712 and reach the goal point 1714.

An agricultural mode path 1722, which is a path displayed by a solid line, is an optimal path generated by a path planner 1660 when an agricultural mode is selected in a mission planner 1655. A mission objective of the agricultural mode is to minimize soil compaction of farmland. For this, the mission planner 1655 sets a weight of a cost element related to soil compaction in a cost function to be high. For example, the weight is adjusted to prefer hard ground and avoid soft soil. As a result, the path planner 1660 generates the agricultural mode path 1722 that may minimize soil compaction and passes through the low-cost area 1716 as much as possible, even when it bypasses the medium-cost area 1717 or the high-cost area 1718 on the traversability map 1700. As illustrated in FIG. 17, the agricultural mode path 1722 departs from the start point 1712, first moves rightward, then passing through a lower portion along the low-cost area 1716, rises along a right edge, and heads toward the goal point 1714. This path minimizes soil compaction by preferentially selecting the low-cost area 1716, which is hard ground, even though a distance is somewhat long.

A leisure mode path 1732, which is a path displayed by a dotted line, is an optimal path generated by the path planner 1660 when a leisure mode is selected in the mission planner 1655. A mission objective of the leisure mode is to prioritize ride comfort of a driver or an occupant. For this, the mission planner 1655 sets a weight of a cost element related to ride comfort in a cost function to be high. For example, the weight is adjusted to minimize roughness of the ground, vibration, an abrupt direction change, and the like. As a result, the path planner 1660 selects a smooth path having the lowest roughness or vibration of the overall driving path even when it passes through a portion of the medium-cost area 1717. As illustrated in FIG. 17, the leisure mode path 1732 moves in a diagonal direction close to the shortest distance from the start point 1712 to the goal point 1714. This path passes through a portion of the medium-cost area 1717, but provides a smooth path closest to a straight line as a whole, thereby maximizing ride comfort. The leisure mode path 1732 is a path clearly distinguished from the agricultural mode path 1722.

As such, FIG. 17 shows that, even for the same terrain environment and the same start point 1712 and goal point 1714, the different driving paths 1722 and 1732 optimized for each situation may be generated by dynamically adjusting a cost function according to a mission objective of a user. The agricultural mode path 1722 is a path preferring hard ground by prioritizing minimization of soil compaction, and the leisure mode path 1732 is a path preferring the shortest distance and smooth driving by prioritizing ride comfort. The present invention provides a high level of adaptability and versatility through this dynamic path planning for each mission objective, compared with an autonomous driving system using an existing fixed cost function.

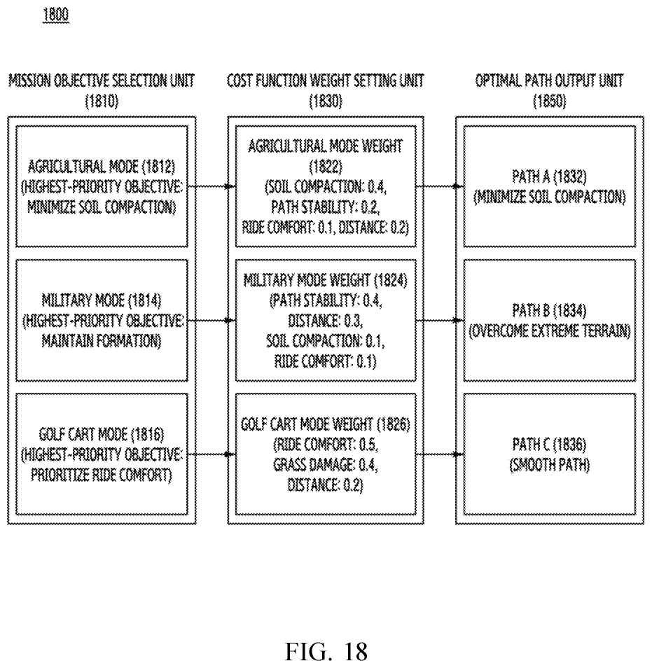

FIG. 18 is a conceptual diagram for describing an operation of a mission planner and a path planner illustrated in FIG. 16 in more detail. FIG. 18 includes a mission objective selection unit 1810, a cost function weight setting unit 1830, and an optimal path output unit 1850. The mission objective selection unit 1810 and the cost function weight setting unit 1830 correspond to the mission planner 1655 of FIG. 16, and the optimal path output unit 1850 corresponds to an output of the path planner 1660 of FIG. 16.

Referring to FIG. 18, a mission objective is input to the mission objective selection unit 1810 from a user or an external system. The mission objective selection unit 1810 provides various mission modes selectable by the user. For example, the mission objective selection unit 1810 includes an agricultural mode 1812, a military mode 1814, and a golf cart mode 1816. Each mission mode has a unique highest-priority objective.

The agricultural mode 1812 has the highest-priority objective of minimizing soil compaction when a vehicle drives on farmland. In an agricultural environment, it is important to reduce a negative effect on growth of crops by minimizing compaction of soil on which the crops are cultivated. Accordingly, when the agricultural mode 1812 is selected, a path preferring hard ground and avoiding soft soil is generated.

The military mode 1814 has the highest-priority objective of maintaining a vehicle formation in a military operation environment. A military vehicle often move in a formation with a plurality of vehicles, and should stably drives while maintaining the formation even in extreme terrain. Accordingly, when the military mode 1814 is selected, stability of a path and maintenance of a formation are importantly considered.

The golf cart mode 1816 has the highest-priority objective of prioritizing ride comfort of an occupant in a leisure environment such as a golf course. A golf cart mainly drives on flat grass, and should provides a smooth and pleasant driving experience to an occupant. Accordingly, when the golf cart mode 1816 is selected, ride comfort and minimization of grass damage are importantly considered.

The cost function weight setting unit 1830 dynamically sets a weight for each cost element of a cost function to be used when planning a path, according to a mission objective selected in the mission objective selection unit 1810. The cost function is used to calculate a total cost of a path on a traversability map 1700, and is represented as a weighted sum of a plurality of cost elements. The cost elements may include, for example, soil compaction, path stability, ride comfort, a distance, grass damage, and the like.

When the agricultural mode 1812 is selected, the cost function weight setting unit 1830 sets an agricultural mode weight 1822. In the agricultural mode weight 1822, a weight for soil compaction is set to 0.4, which is the highest, such that minimizing soil compaction is considered with the highest priority. In addition, a weight for path stability is set to 0.2 such that maintaining crop row accuracy is considered, a weight for ride comfort is set low to 0.1, and a weight for a distance is set to 0.2. According to this weight setting, in the agricultural mode, a path minimizing soil compaction is preferentially selected.

When the military mode 1814 is selected, the cost function weight setting unit 1830 sets a military mode weight 1824. In the military mode weight 1824, a weight for path stability is set to 0.4, which is the highest, such that a path capable of stable driving even in extreme terrain is preferentially selected. A weight for a distance is set to 0.3 such that a path length for maintaining a formation is importantly considered, and weights for soil compaction and ride comfort are each set low to 0.1. According to this weight setting, in the military mode, a path capable of maintaining a formation while overcoming extreme terrain is preferentially selected.

When the golf cart mode 1816 is selected, the cost function weight setting unit 1830 sets a golf cart mode weight 1826. In the golf cart mode weight 1826, a weight for ride comfort is set to 0.5, which is the highest, such that providing a smooth and pleasant driving experience to an occupant is considered with the highest priority. In addition, a weight for grass damage is set high to 0.4 such that protecting grass of a golf course is importantly considered, and a weight for a distance is set to 0.2. According to this weight setting, in the golf cart mode, a path minimizing grass damage and ensuring smooth driving is preferentially selected.

The weights are exemplary values, and may be adjusted according to an actual driving environment or a user's preference. An important point is that path planning optimized for each mission situation is possible by differently applying weights according to a mission objective for the same cost elements.

The optimal path output unit 1850 searches for an optimal path on the traversability map, and outputs a result by applying a cost function weight set in the cost function weight setting unit 1830. The optimal path output unit 1850 corresponds to the output of the path planner 1660 of FIG. 16. An optimal path is determined as a path having the lowest total cost obtained by applying a weight to a cost of each grid cell.

When the agricultural mode weight 1822 is applied, the optimal path output unit 1850 generates a path A 1832 minimizing soil compaction. The path A 1832 minimizes soil compaction by preferentially passing through a low-cost area, which is hard ground.

When the military mode weight 1824 is applied, the optimal path output unit 1850 generates a path B 1834 for overcoming extreme terrain and maintaining a formation. The path B 1834 selects a path capable of stable driving even in rough terrain by preferentially considering stability of the path.

When the golf cart mode weight 1826 is applied, the optimal path output unit 1850 generates a path C 1836 minimizing grass damage and ensuring smooth driving. The path C 1836 selects a smooth path having the best ride comfort and minimizing an effect on the grass.

As such, FIG. 18 shows that different optimal paths may be generated by differently applying a weight according to a mission objective for the same cost elements. The present invention enables universal path planning satisfying various requirements as one system by differently combining, in real time, weights for a plurality of predefined cost elements according to a mission objective. This provides a high level of adaptability and flexibility compared with an autonomous driving system using an existing fixed cost function.

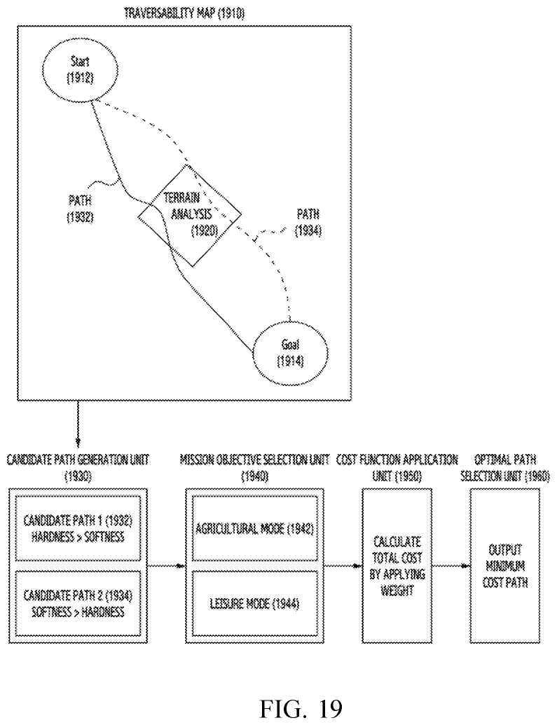

FIG. 19 is a flowchart illustrating a flow of an optimal path generation algorithm according to an embodiment of the present invention. FIG. 19 shows an entire process from a traversability map 1910 to selecting a final optimal path step by step.

Referring to FIG. 19, the optimal path generation algorithm includes the traversability map 1910, a candidate path generation unit 1930, a mission objective selection unit 1940, a cost function application unit 1950, and an optimal path selection unit 1960.

The traversability map 1910 corresponds to the integrated traversability map generated by the traversability analysis module 1645 of FIG. 16. The traversability map 1910 represents terrain in front of a vehicle in a grid form, and each grid cell has a driving cost comprehensively considering a type of terrain, a slope, roughness, a negative obstacle, and the like. On the traversability map 1910, a start point 1912 and a goal point 1914 of a vehicle are set. The start point 1912 indicates a current position of the vehicle, and the goal point 1914 indicates a final destination to which the vehicle should reach.

Terrain analysis 1920 is a step of analyzing possible paths between the start point 1912 and the goal point 1914 on the traversability map 1910. The terrain analysis 1920 analyzes characteristics of various paths capable of reaching the goal point 1914 from the start point 1912 based on cost information of the traversability map 1910. This analysis identifies a characteristic of terrain through which each path passes and transmits it to the candidate path generation unit 1930.

The candidate path generation unit 1930 generates a plurality of candidate paths based on a result of the terrain analysis 1920. Each candidate path has a unique cost profile according to a characteristic of terrain. In FIG. 19, two representative candidate paths are illustrated.

A candidate path 1 1932 is a path having a cost profile of “hardness >softness”. This means that the path mainly passes through hard ground and includes hard terrain more than soft terrain. The candidate path 1 1932 may be suitable for a mission prioritizing minimization of soil compaction or stability of a vehicle.

A candidate path 2 1934 is a path having a cost profile of “softness >hardness”. This means that the path mainly passes through soft terrain and includes soft terrain more than hard terrain. The candidate path 2 1934 may be suitable for a mission prioritizing ride comfort or emphasizing smoothness of the path.

In practice, a plurality of such candidate paths may be generated, and each candidate path has a unique cost profile according to various characteristics such as hardness, softness, a slope, roughness, a distance, and the like.

A mission objective is input to the mission objective selection unit 1940 from a user or an external system. The mission objective selection unit 1940 corresponds to the mission objective selection unit 1810 of FIG. 18. In FIG. 19, an agricultural mode 1942 and a leisure mode 1944 are illustrated.

The agricultural mode 1942 has the highest-priority objective of minimizing soil compaction. When the agricultural mode 1942 is selected, a cost function weight preferring hard ground is set.

The leisure mode 1944 has the highest-priority objective of prioritizing ride comfort of an occupant. When the leisure mode 1944 is selected, a cost function weight preferring a soft and flat path is set.

The cost function application unit 1950 calculates a total cost by applying a weight set according to a mission objective selected in the mission objective selection unit 1940 to a cost profile of each candidate path. The cost function application unit 1950 calculates a total cost of each candidate path by using a weight set in the cost function weight setting unit 1830 of FIG. 18.

For example, when the agricultural mode 1942 is selected, since a weight for soil compaction is set high, a total cost of the candidate path 1 1932 including much hard ground is calculated to be relatively low. On the other hand, when the leisure mode 1944 is selected, since a weight for ride comfort is set high, a total cost of the candidate path 2 1934 including much soft terrain is calculated to be relatively low.

The cost function application unit 1950 may calculate a total cost for each candidate path according to the following equation. Total cost=w1×soil compaction cost+w2×path stability cost+w3×ride comfort cost+w4×distance cost+ . . . . Herein, the w1, the w2, the w3, and the w4 are weights set according to a mission objective. As such, since the weights vary according to the mission objective even for the same candidate path, a total cost becomes different.

The optimal path selection unit 1960 compares total costs calculated by the cost function application unit 1950 and selects and outputs a path having the lowest total cost as a final optimal path. The optimal path selection unit 1960 corresponds to an output of the path planner 1660 of FIG. 16.

For example, when the agricultural mode 1942 is selected, since the candidate path 1 1932 including much hard ground has a minimum cost, it is selected as an optimal path. On the other hand, when the leisure mode 1944 is selected, since the candidate path 2 1934 including much soft terrain has a minimum cost, it is selected as an optimal path.

The optimal path selection unit 1960 transmits a selected optimal path to the vehicle controller 1665 of FIG. 16, and the vehicle controller 1665 generates a steering command and a speed command for driving a vehicle along this path.

As such, FIG. 19 clearly shows an entire flow of an algorithm that generates the plurality of candidate paths 1932 and 1934 through the terrain analysis 1920 and selects the optimal path 1960 by applying the cost function 1950 according to the mission objectives 1942 and 1944. The present invention provides an intelligent path planning capability capable of flexibly selecting an optimal path according to a mission objective even for the same traversability map and candidate paths through this dynamic cost function application.

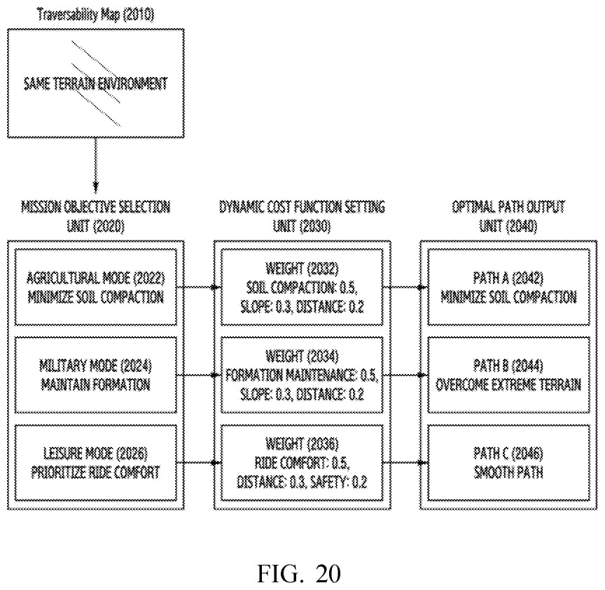

FIG. 20 is a conceptual diagram comprehensively illustrating a process in which different optimal paths are generated by applying a dynamic cost function according to a mission purpose even when the same terrain environment is input, according to an embodiment of the present invention. FIG. 20 presents an entire flow of the path planning process for each mission objective described in FIGS. 16 to 19 as one integrated view.

Referring to FIG. 20, an entire system includes a Traversability Map 2010, a mission objective selection unit 2020, a dynamic cost function setting unit 2030, and an optimal path output unit 2040.

The traversability map 2010 corresponds to an integrated traversability map generated by the traversability analysis module 1645 of FIG. 16. The traversability map 2010 represents terrain information of an unpaved road environment in a grid form, and indicates the same terrain environment. In an upper left end of the traversability map 2010, lines in a diagonal direction are displayed to visually indicate a characteristic of terrain. This map is input data commonly used for three different mission objectives.

A mission objective is input to the mission objective selection unit 2020 from a user or an external system. The mission objective selection unit 2020 corresponds to the mission planner 1655 of FIG. 16 and the mission objective selection unit 1810 of FIG. 18. In FIG. 20, three representative mission modes are illustrated.

An agricultural mode 2022 has the highest-priority objective of minimizing soil compaction. In an agricultural environment, when a vehicle drives, it is important to reduce a negative effect on growth of crops by minimizing compaction of soil on which the crops are cultivated. When the agricultural mode 2022 is selected, a weight corresponding to this is transmitted to the dynamic cost function setting unit 2030.

A military mode 2024 has the highest-priority objective of maintaining a formation. In a military operation environment, a plurality of vehicles move in a formation, and should stably drive while maintaining the formation even in extreme terrain. When the military mode 2024 is selected, a weight corresponding to this is transmitted to the dynamic cost function setting unit 2030.

The leisure mode 2026 has the highest-priority objective of prioritizing ride comfort. In a leisure environment, it is most important to provide a smooth and pleasant driving experience to an occupant. When the leisure mode 2026 is selected, a weight corresponding to this is transmitted to the dynamic cost function setting unit 2030.

The dynamic cost function setting unit 2030 dynamically sets a weight for each cost element of a cost function according to a mission objective selected in the mission objective selection unit 2020. The dynamic cost function setting unit 2030 corresponds to the mission planner 1655 of FIG. 16 and the cost function weight setting unit 1830 of FIG. 18. In FIG. 20, specific weight values for the three mission modes are illustrated.

A weight 2032 is a cost function weight corresponding to the agricultural mode 2022. In the weight 2032, a weight for soil compaction is set to 0.5, which is the highest, such that minimizing soil compaction is considered with the highest priority. In addition, a weight for a slope is set to 0.3 such that a slope of terrain is importantly considered, and a weight for a distance is set to 0.2. According to this weight setting, in the agricultural mode, a path having a gentle slope while minimizing soil compaction is preferentially selected.

A weight 2034 is a cost function weight corresponding to the military mode 2024. In the weight 2034, a weight for formation maintenance is set to 0.5, which is the highest, such that maintaining a vehicle formation is considered with the highest priority. In addition, a weight for a distance is set to 0.3 such that a path length for maintaining the formation is importantly considered, and a weight for a slope is set to 0.2. According to this weight setting, in the military mode, a stable path capable of maintaining the formation even in extreme terrain is preferentially selected.

A weight 2036 is a cost function weight corresponding to the leisure mode 2026. In the weight 2036, a weight for ride comfort is set to 0.5, which is the highest, such that ride comfort of an occupant is considered with the highest priority. In addition, a weight for a distance is set to 0.3, and a weight for safety is set to 0.2. According to this weight setting, in the leisure mode, a path providing smooth and pleasant driving is preferentially selected.

The optimal path output unit 2040 outputs an optimal path calculated by applying a weight set in the dynamic cost function setting unit 2030. The optimal path output unit 2040 corresponds to the path planner 1660 of FIG. 16 and the optimal path output unit 1850 of FIG. 18. In FIG. 20, different optimal paths for the three mission modes are illustrated.

A path A 2042, which is an optimal path corresponding to the agricultural mode 2022, is a path minimizing soil compaction. By applying the weight 2032, a path preferentially passing through hard ground having low soil compaction is selected. The path A 2042 minimizes an effect on crop growth in farmland by minimizing soil compaction.

A path B 2044, which is an optimal path corresponding to the military mode 2024, is a path for overcoming extreme terrain. By applying the weight 2034, a path enabling formation maintenance and having high path stability is selected. The path B 2044 provides a path on which stable driving is possible while maintaining a vehicle formation even in rough terrain.

A path C 2046, which is an optimal path corresponding to the leisure mode 2026, is a smooth path. By applying the weight 2036, a smooth path having the best ride comfort and low roughness of ground is selected. The path C 2046 provides a pleasant and comfortable driving experience to an occupant.

As such, FIG. 20 comprehensively shows a process in which, even when the same traversability map 2010 is input, different dynamic cost functions are respectively applied according to a selected mission objective, and as a result, different optimal paths are generated. The present invention implements a high level of intelligent autonomous driving that understands a context of a given mission beyond simple obstacle avoidance and actively finds an optimal answer most suitable therefor through this dynamic cost function mechanism. This provides universal and adaptive path planning capability capable of satisfying requirements of various application fields with one system.

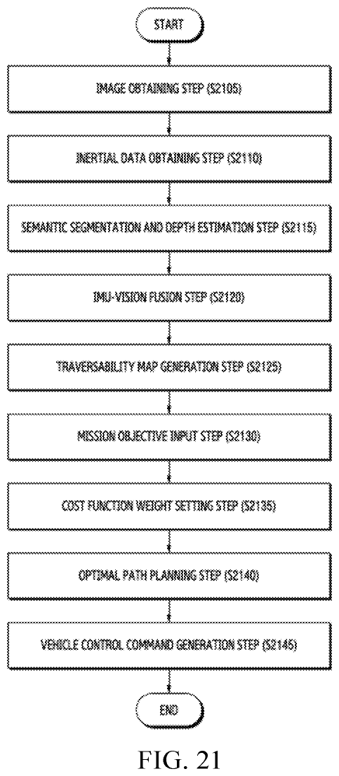

FIG. 21 is a flowchart illustrating a flow of an unpaved road autonomous driving path planning method according to an embodiment of the present invention. FIG. 21 represents an operation of the autonomous driving system 1600 described in FIG. 16 in detail step by step from a perspective of a method.

Referring to FIG. 21, the unpaved road autonomous driving path planning method starts from an initiation step, pass through an image obtaining step S2105, an inertial data obtaining step S2110, a semantic segmentation and depth estimation step S2115, an IMU-Vision fusion step S2120, a traversability map generation step S2125, a mission objective input step S2130, a cost function weight setting step S2135, an optimal path planning step S2140, and a vehicle control command generation step S2145, and proceeds to a termination step.

The image obtaining step S2105 is a step of obtaining an image by capturing an unpaved road environment in front of a vehicle via a monocular camera mounted on the vehicle. The image obtaining step S2105 corresponds to an operation performed by the camera 1620 of FIG. 16. The obtained image includes terrain, an obstacle, an object, and the like of an unpaved road, and is used as basic input data for environment recognition in a subsequent step. The image may be obtained as continuous frames, and is collected at a constant frame rate for real-time processing.

The inertial data obtaining step S2110 is a step of obtaining inertial data of a vehicle via an inertial measurement unit (IMU) mounted on the vehicle. The inertial data obtaining step S2110 corresponds to an operation performed by the inertial measurement unit 1615 of FIG. 16. The obtained inertial data includes 3-axis acceleration and 3-axis angular velocity of the vehicle, and information such as a posture change, a moving speed, acceleration, and the like of the vehicle may be identified in real time through this. The inertial data is collected in synchronization with the image obtaining step S2105, and is coupled with image information in a subsequent fusion step.

The semantic segmentation and depth estimation step S2115 is a step of performing semantic segmentation and depth estimation on the image obtained in the image obtaining step S2105. The semantic segmentation and depth estimation step S2115 corresponds to an operation performed by the recognition module 1635 of FIG. 16. The semantic segmentation may be performed by using the artificial intelligence model described in FIGS. 1 to 15, and classifies a class of an object for each pixel or area of the image. For example, it identifies various terrain elements and objects existing in an unpaved road environment, such as a dirt road, grass, a tree, a rock, a ditch, and the like. The depth estimation, which is a process of estimating a relative distance to each pixel from a monocular image, may be performed through a deep learning-based depth estimation network. A semantic segmentation result and a depth estimation result are respectively transmitted to a subsequent step as object information and depth information.

The IMU-Vision fusion step S2120 is a step of generating three-dimensional terrain information by tightly coupling the inertial data obtained in the inertial data obtaining step S2110 and the depth information estimated in the semantic segmentation and depth estimation step S2115. The IMU-Vision fusion step S2120 corresponds to an operation performed by the fusion module 1640 of FIG. 16. In this step, it fuses movement of a vehicle estimated via the inertial data and a visual change between image frames by using an Extended Kalman Filter or a similar sensor fusion algorithm. Through this, a Scale Ambiguity problem that is difficult to solve only with a monocular camera may be solved, and accurate and consistent three-dimensional terrain information may be generated by correcting a driving distance error (Drift) accumulated over time. The generated three-dimensional terrain information includes three-dimensional coordinates and height information on terrain in front of the vehicle.

The traversability map generation step S2125 is a step of generating an integrated traversability map by comprehensively using the three-dimensional terrain information generated in the IMU-Vision fusion step S2120 and the semantic segmentation result obtained in the semantic segmentation and depth estimation step S2115. The traversability map generation step S2125 corresponds to an operation performed by the traversability analysis module 1645 of FIG. 16. The integrated traversability map is a two-dimensional map obtained that divides a space in front of a vehicle in a Grid form and allocates a driving cost to each grid cell. The driving cost is calculated by comprehensively considering a type of terrain, a slope, roughness, a negative obstacle, and the like. For example, a hard dirt road has a low cost, soft soil or mud has an intermediate cost, and a ditch or a pit having a risk that a vehicle may become stuck has a very high cost. The generated traversability map may be represented in a form similar to the traversability map 1700 of FIG. 17.

The mission objective input step S2130 is a step in which a mission objective is input from a user or an external system. The mission objective input step S2130 corresponds to an operation performed by the mission planner 1655 of FIG. 16 and the mission objective selection unit 1810 of FIG. 18. The mission objective indicates a goal or priority of driving to be performed by a vehicle, and may be, for example, an agricultural mode, a military mode, a leisure mode, a golf cart mode, and the like. A user may select a mission objective via an interface of a vehicle, or the mission objective may be automatically set from an external system. The input mission objective is used to dynamically set a cost function weight in a subsequent step.

The cost function weight setting step S2135 is a step of dynamically setting a weight for each cost element of a cost function to be used when planning a path according to the mission objective input in the mission objective input step S2130. The cost function weight setting step S2135 corresponds to an operation performed by the mission planner 1655 of FIG. 16 and the cost function weight setting unit 1830 of FIG. 18. The cost function includes various cost elements such as soil compaction, path stability, ride comfort, a distance, grass damage, and the like, and a weight for each cost element is differently set according to a mission objective. For example, when the agricultural mode is selected, a weight for soil compaction is set high, and when a leisure mode is selected, a weight for ride comfort is set high. The set weight is used to plan an optimal path in a subsequent step.

The optimal path planning step S2140 is a step of planning an optimal path by using the integrated traversability map generated in the traversability map generation step S2125 and the cost function weights set in the cost function weight setting step S2135. The optimal path planning step S2140 corresponds to an operation performed by the path planner 1660 of FIG. 16. In this step, it searches for a path having the lowest accumulated cost among paths from a current position to a goal point by using an A* algorithm, a Rapidly-exploring Random Tree Star (RRT*) algorithm, or a similar graph search algorithm. Since the cost function weight is dynamically set according to a mission objective, different optimal paths may be generated according to the mission objective even on the same traversability map. For example, in the agricultural mode, a path minimizing soil compaction is selected as an optimal path, and in the leisure mode, a smooth path having good ride comfort is selected as an optimal path. The planned optimal path is transmitted to the vehicle control command generation step.

The vehicle control command generation step S2145 is a step of generating a steering command and a speed command such that a vehicle drives along the optimal path planned in the optimal path planning step S2140. The vehicle control command generation step S2145 corresponds to an operation performed by the vehicle controller 1665 of FIG. 16. In this step, it may generate a control command such that a vehicle accurately follows the planned path by using a PID controller, a Model Predictive Control (MPC) controller, or a similar control algorithm. The generated steering command controls a steering angle of the vehicle, and the speed command controls acceleration or deceleration of the vehicle. The generated control command is transmitted to the vehicle drivetrain 1680 via the output unit 1670 of FIG. 16, thereby controlling a steering angle and a speed of an actual vehicle.

As such, FIG. 21 clearly shows a flow of an overall method of recognizing an environment by using a monocular camera and an inertial measurement unit, which are a low-cost sensor combination, in an unpaved road environment and controlling a vehicle by planning a driving path dynamically optimized according to a mission objective, step by step. A method of the present invention may be repeatedly performed in real time and may continuously adapt to a dynamically changing environment, and through this, safe and efficient autonomous driving in the unpaved road environment may be realized.

According to an embodiment, an electronic device 101 for controlling a vehicle 210 is disclosed. The electronic device 101 may comprise a camera 130. The electronic device 101 may comprise at least one processor 110. The at least one processor 110 may be configured to obtain an image 401 via the camera 130. The at least one processor 110 may be configured to obtain a depth map 501 corresponding to the image 401 by inputting the image 401 to a trained model. The at least one processor 110 may be configured to determine a driving path 510 of the vehicle 210 by using the depth map 501 for autonomous driving of the vehicle 210 positioned off a paved road 230. The at least one processor 110 may be configured to generate a control signal for controlling the vehicle 210 in accordance with the determined driving path 510.

The at least one processor 110 may be configured to identify a slope of a ground area included in the image 401 by using the depth map 501. The at least one processor 110 may be configured to, based on the slope of the ground area identified as above a threshold slope, determine the driving path 510 of the vehicle 210 to avoid the ground area.

The at least one processor 110 may be configured to obtain specification information of the vehicle 210. The at least one processor 110 may be configured to, based on the specification information of the vehicle 210, determine the driving path 510 of the vehicle 210.

The specification information of the vehicle 210 may include a width of the vehicle 210, a height of the vehicle 210, and/or a distance between a front-wheel axle of the vehicle 210 and the camera 130.

The electronic device 101 may comprise a weight sensor 140.

The at least one processor 110 may be configured to obtain a weight of the vehicle 210 via the weight sensor 140. The at least one processor 110 may be configured to, based on the weight of the vehicle 210, determine the driving path 510 of the vehicle 210.

The at least one processor 110 may be configured to identify a slope of the driving path 510 by using the depth map 501. The at least one processor 110 may be configured to, based on the slope of the driving path 510 and the weight of the vehicle 210, determine a driving speed of the vehicle 210. The at least one processor 110 may be configured to generate the control signal in accordance with the determined driving speed.

The at least one processor 110 may be configured to identify a curvature of the driving path 510 by using the depth map 501. The at least one processor 110 may be configured to determine a driving speed of the vehicle 210 based on the curvature of the driving path 510 and the weight of the vehicle 210. The at least one processor 110 may be configured to generate the control signal in accordance with the determined driving speed.

According to an embodiment, an electronic device 101 for controlling a vehicle 210 is disclosed. The electronic device 101 may comprise a camera 130. The electronic device 101 may comprise at least one processor 110. The at least one processor 110 may be configured to obtain an image 401 via the camera 130. The at least one processor 110 may be configured to, when the vehicle 210 is positioned on a paved road 230, determine a first driving path of the vehicle 210 based on a shape of the paved road 230 identified by using the image 401. The at least one processor 110 may be configured to, when the vehicle 210 is positioned on a paved road 230, generate a first control signal for controlling the vehicle 210 according to the first driving path. The at least one processor 110 may be configured to, when the vehicle 210 is positioned off the paved road 230, obtain a depth map 501 corresponding to the image 401 by inputting the image 401 to a trained model. The at least one processor 110 may be configured to, when the vehicle 210 is positioned off the paved road 230, determine a second driving path 510 of the vehicle 210 by using the depth map 501. The at least one processor 110 may be configured to, when the vehicle 210 is positioned off the paved road 230, generate a second control signal for controlling the vehicle 210 according to the second driving path 510.

The at least one processor 110 may be configured to determine whether the vehicle 210 is positioned on the paved road 230 by inputting the image 401 to an artificial intelligence (AI) model trained to identify external objects included in the image 401.

The at least one processor 110 may be configured to identify a slope of a ground area included in the image 401 by using the depth map 501. The at least one processor 110 may be configured to, based on the slope of the ground area identified as above a threshold slope, determine the second driving path 510 of the vehicle 210 to avoid the ground area.

The at least one processor 110 may be configured to obtain specification information of the vehicle 210. The at least one processor 110 may be configured to, based on the specification information of the vehicle 210, determine the driving path 510 of the vehicle 210.

The specification information of the vehicle 210 may include a width of the vehicle 210, a height of the vehicle 210, and/or a distance between a front-wheel axle of the vehicle 210 and the camera 130.

The electronic device 101 may comprise a weight sensor 140. The at least one processor 110 may be configured to obtain a weight of the vehicle 210 via the weight sensor 140. The at least one processor 110 may be configured to determine the second driving path 510 of the vehicle 210 based on the weight of the vehicle 210.

The at least one processor 110 may be configured to identify a slope of the second driving path 510 by using the depth map 501. The at least one processor 110 may be configured to, based on the slope of the second driving path 510 and the weight of the vehicle 210, determine a driving speed of the vehicle 210. The at least one processor 110 may be configured to generate the second control signal in accordance with the determined driving speed.

The at least one processor 110 may be configured to identify a curvature of the second driving path 510 by using the depth map 501. The at least one processor 110 may be configured to, based on the curvature of the second driving path 510 and the weight of the vehicle 210, determine a driving speed of the vehicle 210. The at least one processor 110 may be configured to generate the second control signal in accordance with the determined driving speed.

A method executed by an electronic device 101 including a camera 130 and at least one processor 110 is provided. The method may comprise obtaining an image 401 via the camera 130. The method may comprise obtaining a depth map 501 corresponding to the image 401 by inputting the image 401 to a trained model. The method may comprise determining a driving path 510 of the vehicle 210 by using the depth map 501 for autonomous driving of the vehicle 210 positioned off a paved road 230. The method may comprise generating a control signal for controlling the vehicle 210 in accordance with the determined driving path 510.

The method may comprise identifying a slope of a ground area included in the image 401 by using the depth map 501. The method may comprise, based on the slope of the ground area identified as above a threshold slope, determining the driving path 510 of the vehicle 210 to avoid the ground area.

The electronic device 101 may further comprise a weight sensor 140. The method may comprise obtaining a weight of the vehicle 210 via the weight sensor 140. The method may comprise, based on the weight of the vehicle 210, determining the driving path 510 of the vehicle 210.

The method may comprise identifying a slope of the driving path 510 by using the depth map 501. The method may comprise determining a driving speed of the vehicle 210 based on the slope of the driving path 510 and the weight of the vehicle 210. The method may comprise generating the control signal in accordance with the determined driving speed.

The method may comprise identifying a curvature of the driving path 510 by using the depth map 501. The method may comprise, based on the curvature of the driving path 510 and the weight of the vehicle 210, determining a driving speed of the vehicle 210. The method may comprise generating the control signal in accordance with the determined driving speed.

1. An electronic device for controlling a vehicle, comprising:
a camera; and
at least one processor,
wherein the at least one processor is configured to:
obtain an image via the camera;
obtain a depth map corresponding to the image by inputting the image to a trained model;
determine a driving path of the vehicle by using the depth map for autonomous driving of the vehicle positioned off a paved road; and
generate a control signal for controlling the vehicle in accordance with the determined driving path.

2. The electronic device of claim 1,
wherein the at least one processor is configured to:
identify a slope of a ground area included in the image by using the depth map, and
based on the slope of the ground area identified as above a threshold slope, determine the driving path of the vehicle to avoid the ground area.

3. The electronic device of claim 1,
wherein the at least one processor is configured to:
obtain specification information of the vehicle, and
based on the specification information of the vehicle, determine the driving path of the vehicle.

4. The electronic device of claim 3,
wherein the specification information of the vehicle includes a width of the vehicle, a height of the vehicle, and/or a distance between a front-wheel axle of the vehicle and the camera.

5. The electronic device of claim 1, comprising:
a weight sensor, wherein the at least one processor is configured to:
obtain a weight of the vehicle via the weight sensor, and based on the weight of the vehicle, determine the driving path of the vehicle.

6. The electronic device of claim 5,
wherein the at least one processor is configured to:
identify a slope of the driving path by using the depth map,
based on the slope of the driving path and the weight of the vehicle, determine a driving speed of the vehicle, and
generate the control signal in accordance with the determined driving speed.

7. The electronic device of claim 5,
wherein the at least one processor is configured to:
identify a curvature of the driving path by using the depth map,
determine a driving speed of the vehicle based on the curvature of the driving path and the weight of the vehicle, and
generate the control signal in accordance with the determined driving speed.

8. An electronic device for controlling a vehicle, comprising:
a camera; and
at least one processor,
wherein the at least one processor is configured to:
obtain an image via the camera;
when the vehicle is positioned on a paved road:
determine a first driving path of the vehicle based on a shape of the paved road identified by using the image, and
generate a first control signal for controlling the vehicle according to the first driving path; and
when the vehicle is positioned off the paved road:
obtain a depth map corresponding to the image by inputting the image to a trained model,
determine a second driving path of the vehicle by using the depth map, and
generate a second control signal for controlling the vehicle according to the second driving path.

9. The electronic device of claim 8,
wherein the at least one processor is configured to:
determine whether the vehicle is positioned on the paved road by inputting the image to an artificial intelligence (AI) model trained to identify external objects included in the image.

10. The electronic device of claim 8,
wherein the at least one processor is configured to:
identify a slope of a ground area included in the image by using the depth map; and
based on the slope of the ground area identified as above a threshold slope, determine the second driving path of the vehicle to avoid the ground area.

11. The electronic device of claim 8,
wherein the at least one processor is configured to:
obtain specification information of the vehicle, and
based on the specification information of the vehicle, determine the second driving path of the vehicle.

12. The electronic device of claim 11,
wherein the specification information of the vehicle includes a width of the vehicle, a height of the vehicle, and/or a distance between a front-wheel axle of the vehicle and the camera.

13. The electronic device of claim 8, comprising:
a weight sensor,
wherein the at least one processor is configured to:
obtain a weight of the vehicle via the weight sensor, and
determine the second driving path of the vehicle based on the weight of the vehicle.

14. The electronic device of claim 13,
wherein the at least one processor is configured to:
identify a slope of the second driving path by using the depth map,
based on the slope of the second driving path and the weight of the vehicle, determine a driving speed of the vehicle, and
generate the second control signal in accordance with the determined driving speed.

15. The electronic device of claim 13,
wherein the at least one processor is configured to:
identify a curvature of the second driving path by using the depth map,
based on the curvature of the second driving path and the weight of the vehicle, determine a driving speed of the vehicle, and
generate the second control signal in accordance with the determined driving speed.

16. A method executed by an electronic device for controlling a vehicle including a camera and at least one processor, the method comprising:
obtaining an image via the camera;
obtaining a depth map corresponding to the image by inputting the image to a trained model;
determining a driving path of the vehicle by using the depth map for autonomous driving of the vehicle positioned off a paved road; and
generating a control signal for controlling the vehicle in accordance with the determined driving path.

17. The method of claim 16, comprising:
identifying a slope of a ground area included in the image by using the depth map, and
based on the slope of the ground area identified as above a threshold slope, determining the driving path of the vehicle to avoid the ground area.

18. The method of claim 16,
wherein the electronic device further comprises a weight sensor, and
wherein the method comprises:
obtaining a weight of the vehicle via the weight sensor, and
based on the weight of the vehicle, determining the driving path of the vehicle.

19. The method of claim 18,
identifying a slope of the driving path by using the depth map,
determining a driving speed of the vehicle based on the slope of the driving path and the weight of the vehicle, and
generating the control signal in accordance with the determined driving speed.

20. The method of claim 18,
identifying a curvature of the driving path by using the depth map,
based on the curvature of the driving path and the weight of the vehicle, determining a driving speed of the vehicle, and
generating the control signal in accordance with the determined driving speed.
